(19) United States
(12) Patent Application Publication
(10) Pub. No.: US 2004/0041021 A1
(43) Pub. Date: Mar. 4, 2004

(54) Modular self checkout system

(75) Inventor: Paul F. Nugent JR., Alpharetta, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/228,735

(22) Filed: Aug. 27, 2002

(51) Int. Cl. G06K 15/00

(52) U.S. Cl. 235/383

(57) ABSTRACT

A modular self checkout terminal configuration kit includes a set of input modules operative to position a plurality of items for processing, a set of main modules operative to process the items, and a set of output modules operative to position the items for bagging. A modular self checkout terminal is configured from one input module of the set of input modules, one main module of the set of main modules, and one output module of the set of output modules. The set of input modules includes a bumper, an input belt module and/or a shelf. The one main module includes a scanner and/or a weight scale. The set of output modules includes a take-away belt module and/or a bagwell.

### CROSS REFERENCE

Cross reference is made to copending U.S. patent application Ser. No. 09/432,634 (NCR Docket No. 8641), filed Nov. 2, 1999, entitled “Apparatus and Method for Operating a Checkout System Having a Number of Port Expander Devices Associated Therewith” by Robert L. Snyder and commonly assigned herewith.

### TECHNICAL FIELD OF THE INVENTION

The present invention relates generally to a checkout system, and more particularly to a self checkout system for a retail application.

### BACKGROUND OF THE INVENTION

In the retail industry, the largest expenditures are typically the cost of the goods sold followed closely by the cost of labor expended. With particular regard to the retail grocery or supermarket industry, the impetus to reduce labor costs has focused on reducing or eliminating the amount of time required to handle and/or process the items or goods to be purchased by a customer. To this end, there have been a number of self-service checkout systems developed which attempt to substantially eliminate the need for a checkout clerk.

A self-service checkout system is operated by a customer without the aid of a checkout clerk. Hence, during operation of a self-service checkout system, the customer scans individual items for purchase across a scanner and then places the scanned items into a grocery bag, if desired. The customer then pays for his or her purchases either at the self-service checkout system if so equipped, or at a central payment area which is staffed by a store employee. Thus, a self-service checkout system permits a customer to select, itemize, and in some cases pay for his or her purchases without the assistance of the retailer's personnel.

It should be appreciated that a given retailer may have a number of reservations in regard to implementation of self-service checkout systems into the retailer's operation. For example, certain self-service checkout systems which have heretofore been designed are more expensive relative to assisted checkout systems (i.e., retail checkout systems which are operated by an employee of the retailer such as a checkout clerk). The higher cost associated with a self-service checkout system is typically due to the fact that the system itself must perform functions that would normally be performed by the checkout clerk operating the checkout system thereby increasing the number of components associated with the self-service checkout system. For instance, in the case of a self-service checkout system, the system must provide security from improprieties such as theft. Moreover, in certain self-service checkout systems, the checkout system itself must collect payment from the customer for his or her items for purchase. It is the cost of the hardware and software necessary to provide such functions to the self-service checkout system which in certain cases cause the cost of the system to typically exceed the cost of an assisted checkout system.

Moreover, once a self-service checkout system has been set up on the retailer's premises, it is not easy to modify the checkout system to adapt to changing needs of the retailer. Self-service checkout systems which have heretofore been designed include components that are intended to be kept together throughout their useful lives. Thus, the components are attached and connected to each other in a permanent fashion, and are not easy to separate from one another. Further, since the components of the checkout system are intended to be kept together, most of the components are encapsulated in a common cabinet, which makes it even more difficult to separate the components from each other.

Thus, it is not easy to modify a checkout system by, for example, replacing a bagwell with a take-away belt since the cabinetry would also have to be modified. Another problem is that if upgraded, newer versions of the components become available, it is not easy to replace the older version of the component with the newer version.

Further, in self-service checkout systems which have heretofore been designed, it is not possible to switch from a left-hand configuration to a right-hand configuration, or vice versa. In a left-hand configuration, the purchased items flow from the user's left-hand side to his right-hand side. Conversely, in a right-hand configuration, the purchased items flow from the user's right-hand side to his left-hand side. Two sets of checkout system components must be kept in inventory, one set for left-hand configurations and the other set for right-hand configurations. Having to keep two sets of components in inventory increases the inventory costs of both the retailer and the manufacturer/distributor of the checkout system. Yet further, having two sets of checkout system components increases the possibility that a wrong part may be ordered or shipped, such as a left-handed part when a right-handed part is needed.

What is needed therefore is a checkout system which overcomes one or more of the above-mentioned drawbacks. What is particularly needed is a checkout system that may be quickly and easily modified by replacing certain components with other better-suited components as the need arises. For example, if newer versions of components become available, there is a need to be able to replace the older versions of the components with the newer versions. What is further needed is a checkout system including components that may be assembled in either a right-hand or left-hand configuration, thereby reducing the inventory requirements for the components.

### SUMMARY OF THE INVENTION

In accordance with a first embodiment of the present invention, there is provided a modular self checkout terminal configuration kit including a set of input modules operative to position a plurality of items for processing, a set of main modules operative to process the items, and a set of output modules operative to position the items for bagging. A modular self checkout terminal is configured from one input module of the set of input modules, one main module of the set of main modules, and one output module of the set of output modules. The set of input modules includes a bumper, an input belt module and/or a shelf. The one main module includes a scanner and/or a weight scale. The set of output modules includes a take-away belt module and/or a bagwell.

In accordance with a second embodiment of the present invention, there is provided a retail terminal. The retail terminal has an input unit including a first bumper, an input belt module and/or a shelf. The retail terminal also has an output unit including a take-away belt module and/or a bagwell. The retail terminal further has a first main unit including a scanner and/or a first weight scale. The first main unit is associated with the input unit and with the output unit. The first main unit has a first main cabinet separate from the input unit and from the output unit.

In accordance with a third embodiment of the present invention, there is provided a method of configuring a modular self-checkout station, including selecting one input module from a set of input modules, selecting one main module from a set of main modules, and selecting one output module from a set of output modules. The selected one input module, the selected one main module, and the selected output module are assembled into a modular self-checkout station.

It is therefore an object of the present invention to provide a new and useful checkout system.

It is moreover an object of the present invention to provide an improved checkout system.

It is a further object of the present invention to provide a new and useful method of assembling a checkout system.

It is also an object of the present invention to provide an improved method of assembling a checkout system.

It is yet another object of the present invention to provide a low-cost checkout system that may be easily modified to include different components and/or new versions of components.

It is moreover an object of the present invention to provide a checkout system that includes components that may be used in either a left-hand or right-hand configuration, thereby reducing inventory requirements.

The above and other objects, features, and advantages of the present invention will become apparent from the following description and the attached drawings.

### BRIEF DESCRIPTION OF THE DRAWINGS

FIG. 1 is a perspective exploded view of exemplary left-hand components of a modular self checkout terminal configuration kit into which a self checkout terminal or station may be fashioned in accordance with the principles of the present invention;

FIG. 2 is a front view of one embodiment of a left-hand configured self checkout terminal configured from the kit of FIG. 1;

FIG. 3 is a front view of another embodiment of a left-hand configured self checkout terminal configured from the kit of FIG. 1;

FIG. 4 is an enlarged view of an exemplary core module of the modular self checkout terminal configuration kit of FIG. 1;

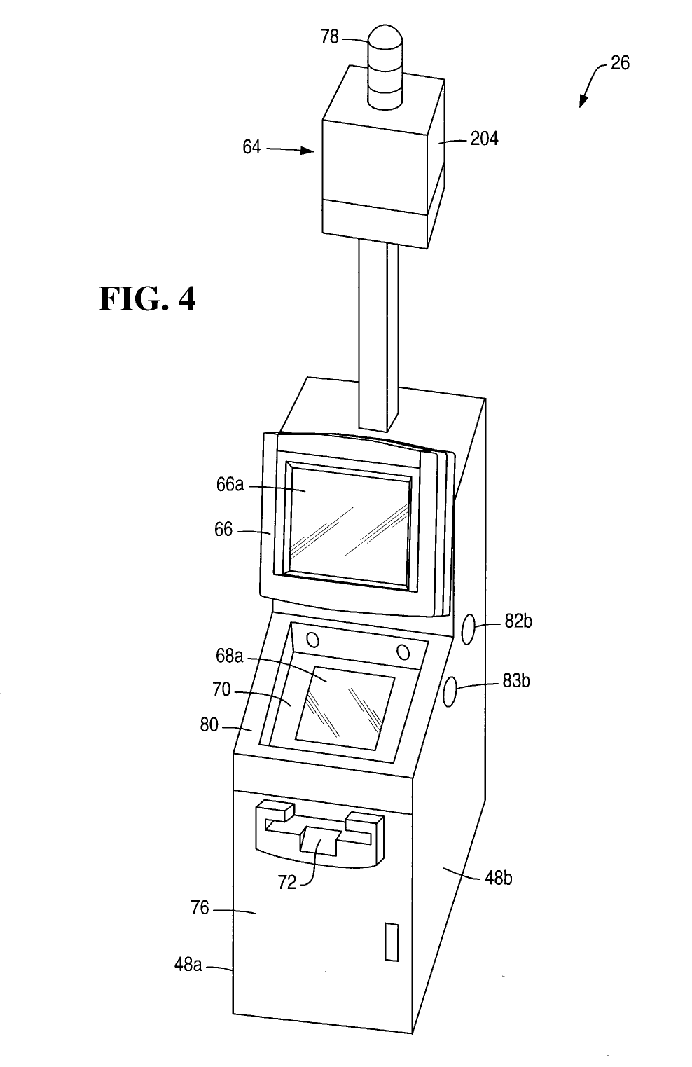

FIG. 5 is an enlarged view of an exemplary currency module of the modular self checkout terminal of FIG. 3;

FIG. 6 is an enlarged view of an exemplary pedestal of the modular self checkout terminal configuration kit of FIG. 1;

FIG. 7 is a fragmentary rear view of an exemplary take-away belt module, an exemplary large bagwell and an exemplary small bagwell of the modular self checkout terminal configuration kit of FIG. 1;

FIG. 8 is an enlarged, perspective view of an exemplary security deactivation module of the modular self checkout terminal of FIG. 3;

FIG. 9 is a simplified block diagram of the checkout system of FIG. 2;

FIGS. 10A and 10B are views similar to FIG. 9, but showing the power distribution architecture of the checkout system of FIG. 2;

FIG. 11 is a flowchart which shows an exemplary general procedure or routine for operating the checkout system of the present invention;

FIG. 12 is a flowchart which shows an exemplary scale security routine for providing security during operation of the checkout system of the present invention;

FIG. 13 is an enlarged perspective view of an exemplary interactive customer interface terminal of the checkout system of FIG. 2;

FIG. 14 is a perspective exploded view of exemplary right-hand components of a modular self checkout terminal configuration kit into which a self checkout terminal or station may be fashioned in accordance with the principles of the present invention; and

FIG. 15 is an enlarged perspective view of an exemplary core module of the modular self checkout terminal configuration kits of FIGS. 1 and 14.

### DETAILED DESCRIPTION OF THE INVENTION

While the invention is susceptible to various modifications and alternative forms, specific embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

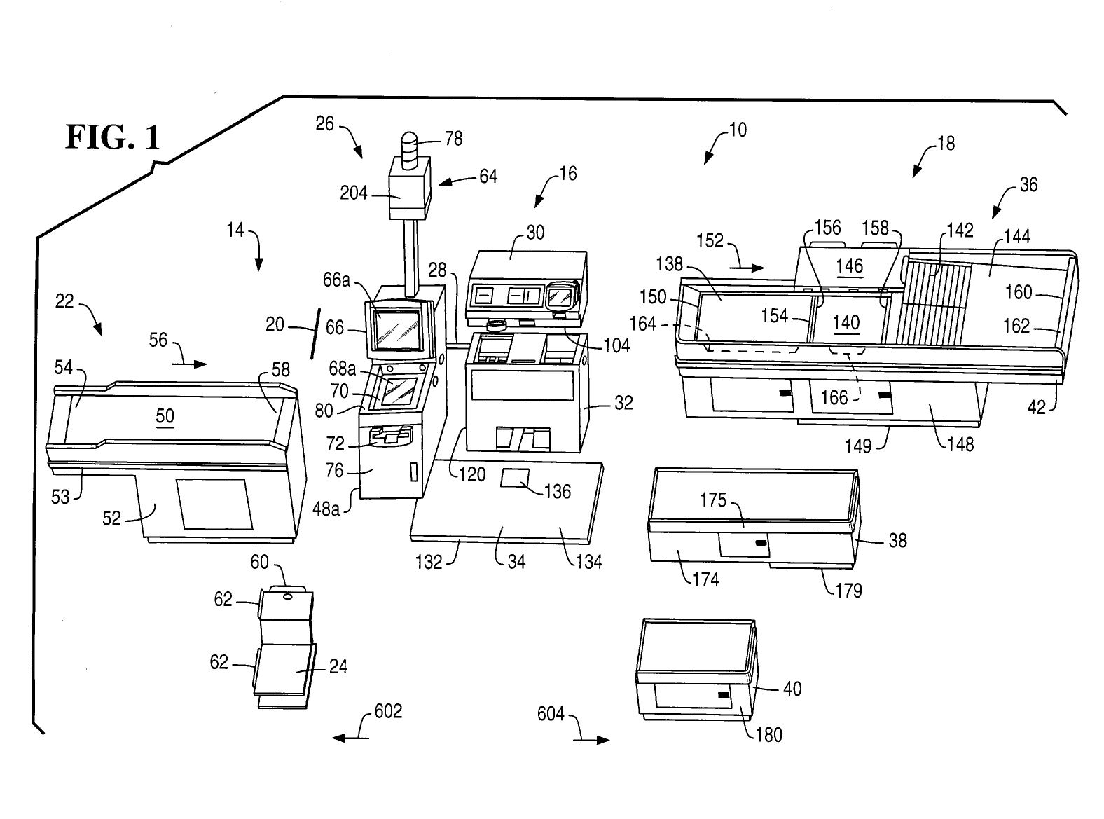

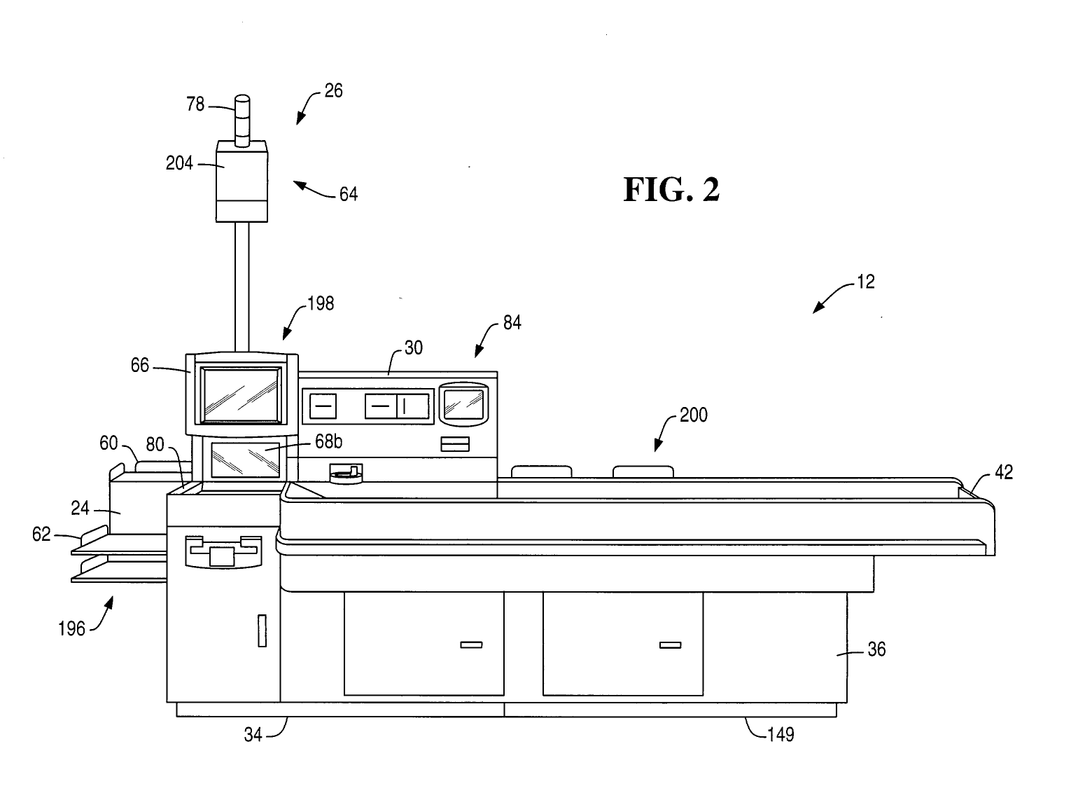

Referring now to FIG. 1, there is shown a modular self-service retail checkout terminal configuration kit 10 from which can be assembled a self-service retail checkout terminal or system, such as a terminal or station 12 (FIG. 2), for use in a retail business such as a grocery store. For purposes of the following discussion, the modular self-service or self checkout terminal configuration kit 10 will be described in detail; however, it should be appreciated that an assisted checkout terminal (i.e., a retail checkout terminal which is operated by a store employee such as a checkout clerk) may be configured in a similar manner.

The checkout system configuration kit 10 includes a set 14 of input units or modules, a set 16 of main units or modules, and a set 18 of output units or modules. The input units receive the item(s) pre-purchase and/or position items to be purchased for processing by the main unit(s). The main units process the items and/or process or effect a purchase transaction, such as by scanning and/or weighing the items, and/or by accepting payment for the items. The output units receive the item(s) post-purchase and/or position the items for bagging. Without being limiting, the set 14 of input units includes a side bumper 20, an input belt module 22 and a basket shelf 24. Without being limiting, the set 16 of main units includes a core module 26, a back bumper 28, an upper currency module 30, a pedestal 32 and a base 34. Without being limiting, the set 18 of output units includes a take-away belt module 36, a large bagwell 38 and a small bagwell 40, each having a separate output cabinet.

In accordance with an aspect of the subject invention, a self checkout terminal or station may be configured in a variety of setups, configurations, et cetera utilizing at least one component of each set of units. More particularly, a self checkout terminal is typically configured utilizing one selected unit of the set 14 of input units, one or more and, preferably, all of the units 26, 28, 30, 32, 34 of the set 16 of main units, and one selected unit of the set 18 of output units.

The terminal 12 (FIG. 2) is one exemplary embodiment of a modular self checkout terminal that can be configured, assembled or designed from the various components of the various units 14, 16, 18 of the terminal configuration kit 10. Particularly, a configured and/or assembled terminal generally includes: a selected one of the input units of the set 14, i.e., a side bumper 20, an input belt module 22 or a basket shelf 24; each one of the main units from set 16, i.e., a core module 26, a back bumper 28, an upper currency module 30, a pedestal 32 and a base 34; and a selected one of the output units of the set 18, i.e., a take-away module 36, a large bagwell 38 or a small bagwell 40. For example, the terminal 12 includes a basket shelf 24, a core module 26, a back bumper 28, an upper currency module 30, a pedestal 32, a base 34, and a takeaway module 36. Other components for each unit not shown may be provided in the kit 10.

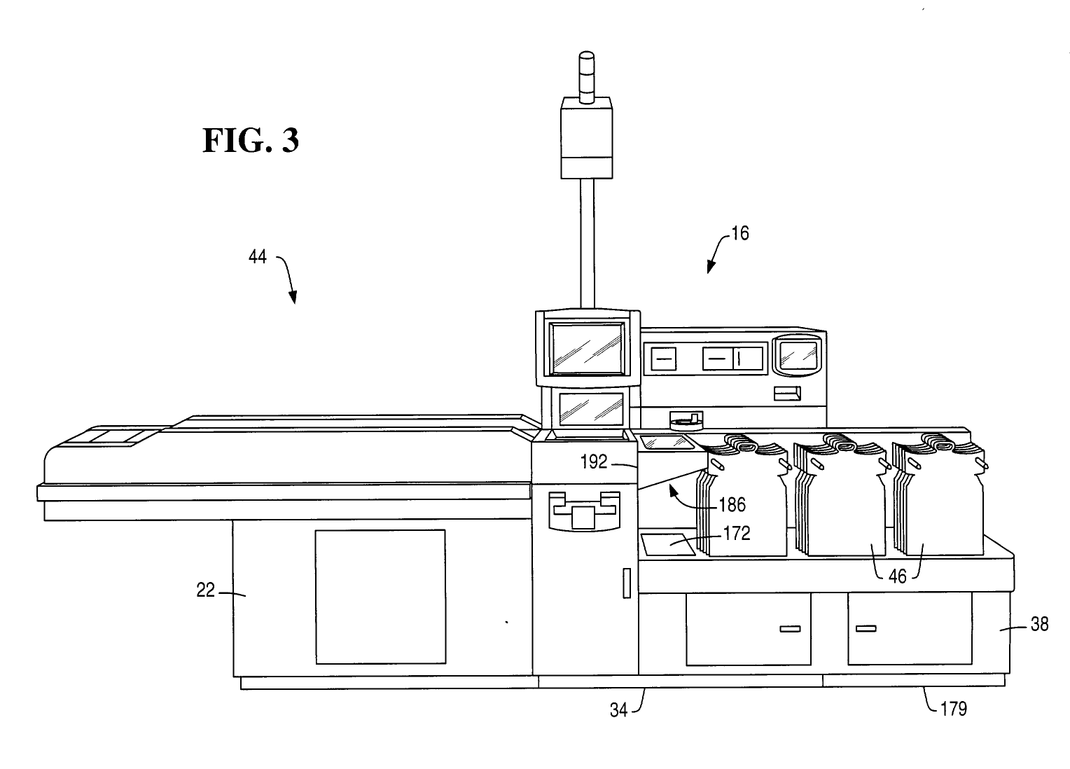

The terminal configuration kit 10 can be configured into nine different combinations in order to form a modular self checkout terminal. That is, for each of the three input units 20, 22 and 24 that can possibly be selected to be included in an assembled terminal, there are three different output units 36, 38 and 40 that can also be selected to be included in the assembled terminal. Which of the nine possible combinations of input units and output units that is selected depends upon the particular application for which the terminal is intended. For example, the terminal 12 of FIG. 2 may be appropriate for an application in which many small items are carried by the shopper in a basket that may be placed on the shelf 24, and employees of the store are available to bag the items at a distal end 42 of the take-away belt module 36. For another example, a terminal 44 (FIG. 3) including an input belt module 22 and a large bagwell 38 may be appropriate for an application in which a large number of items are brought to the terminal 44 in a shopping cart, and it is expected that one person may unload the items from the cart onto the input belt module 22 while another person operates the set 16 of main units and/or places the items into bags 46 on the bagwell 38.

The structure and interaction of each of the units and/or components of the terminal configuration kit 10 will now be described in greater detail. The side bumper 20 is attached to a side surface 48a of the core module 26, and is configured to prevent shopping carts from running into the core module 26. It is the bumper 20 that absorbs the impact of any such errant carts, thereby avoiding dents and scratches in the core module 26.

The input belt module 22 includes an endless rotating input belt 50 driven by an electromechanical drive apparatus such as a motor (not shown) encased in an input belt cabinet 52 having a bumper 53. A user places items to be purchased on the upper surface of belt 50, the upper surface being the surface that is visible in FIG. 1. The user generally places the items on a distal, upstream end 54 of belt 50, and, as the upper surface of the belt 50 rotates in a direction 56, the items are carried from left to right in FIG. 1 toward a proximal, downstream end 58 of the belt 50 in order for the items to be scanned by a user of the checkout system. The terms “upstream” and “downstream” are used herein to be consistent with the flow of items through the checkout system during a typical checkout procedure. The input belt module 22 is not controlled by or powered through the main units 16, but rather is powered through its own dedicated power circuit.

The basket shelf 24 is attached to the side surface 48a of the core module 26, and is configured to support one or more shopping baskets containing items to be purchased. The shelf 24 includes a back rail 60 and side rails 62 for preventing the baskets from sliding off of the shelf 24.

The core module 26 includes a lane light assembly 64, a customer interface terminal 66, a scanner 68, a product scale 70, a bill dispenser 72 and a core module cabinet 76. The lane light assembly 64 includes a status tri-light device 78 provided in order to notify store personnel, such as a customer service manager, if intervention into the current checkout transaction is needed. In particular, if during operation of the checkout system, an intervention-needed activity is detected, the status tri-light device 78 is operated so as to summon retail personnel such as a customer service manager. What is meant herein by the term “intervention-needed activity” is (1) activity by the customer or retail personnel in which the checkout system is unintentionally operated improperly, (2) activity by the customer or retail personnel in which it can be inferred with a high degree of confidence that the checkout system is intentionally operated improperly for illicit purposes such as theft, (3) activity by the customer or retail personnel in which the customer or retail personnel operates an input device associated with the checkout system in a manner which indicates that he or she is in need of assistance, and (4) activity by the components associated with the checkout system which has rendered the system in need of maintenance or other type of service.

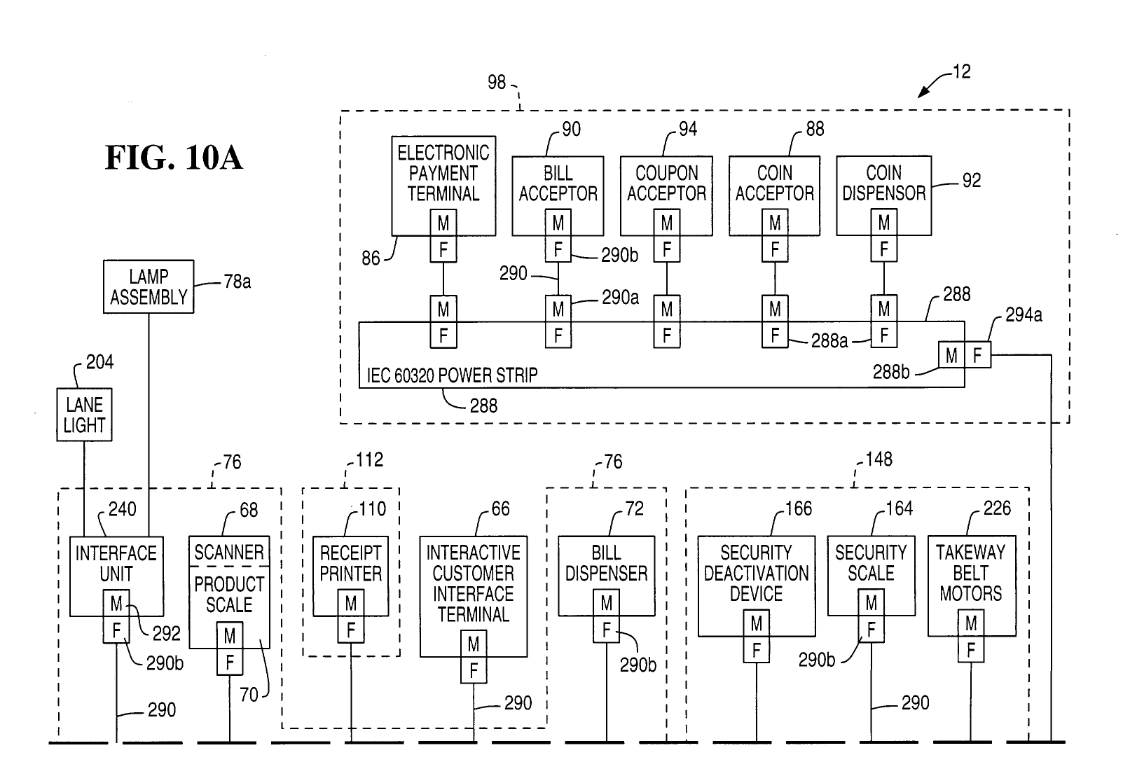

Hence, an intervention-needed activity may take the form of a security-breach activity in which the checkout system is being operated in a manner which is placing the retailer in a position of potential financial loss due to goods being taken from the store without having first been paid for (either intentionally or unintentionally), or a non-security-breach activity in which the customer or checkout clerk is in need of assistance or the checkout system is in need of maintenance, but the retailer is not at risk of financial loss due to goods being taken from the store without having first been paid for. For example, if the customer attempted to scan an item a number of times with the scanner 68, but the product identification code associated with the item was not read by the scanner 68, the processing unit 66b (FIG. 9) concludes that an intervention-needed activity has occurred.

Moreover, it should be appreciated that even if the product identification code associated with the item is entered, the processing unit 66b may determine that an intervention-needed activity has occurred. For example, if the customer scanned a first item, but then placed a second item of greater value into a grocery bag (as detected by, for example, a security scale 164), the processing unit 66b concludes that an intervention-needed activity has occurred. For further example, if the customer or checkout clerk attempts to weigh an item such as produce with the product scale 70, but does not properly position the item on the product scale 70 or has not properly ‘zeroed’ the product scale 70, the processing unit 66b concludes that an intervention-needed activity has occurred.

Yet further examples of intervention-needed activities may include (1) failure to surrender an item after the item has been voided, (2) weighing only a portion of an item (e.g., weighing only one banana, but placing four bananas into a grocery bag), and (3) placing an item into a grocery bag or onto the set-aside shelf 146 without first attempting to scan or otherwise enter the item. Moreover, if the customer touches a particular portion of the touch screen associated with the user interface display monitor 66a, thereby indicating that he or she is in need of assistance, the processing unit 66b concludes that an intervention-needed activity has occurred.

In addition, the processing unit 66b may monitor the status of the retail peripheral devices associated with the checkout system in order to determine if an intervention-needed activity has occurred. For example, the processing unit 66b preferably monitors the currency level within the coin dispenser 92 and the bill dispenser 72 in order to determine if either currency dispenser 72, 92 is in need of restocking. Moreover, the processing unit 66b preferably monitors the paper supply level within the receipt printer 110 in order to determine if the printer 110 is in need of restocking. It should be appreciated that if any one of the currency dispensers 72, 92 or the printer 110 is in need of restocking, the processing unit 66b concludes that an intervention-needed activity has occurred.

It should be appreciated that although numerous examples of intervention-needed activities have herein been described, numerous other types of intervention-needed activities may exist, as defined by a particular retailer or provided by a particular design of the checkout system. Further examples of intervention-needed activities, along with a number of mechanisms and methods for detecting occurrence thereof, are disclosed in U.S. Pat. No. 5,952,642 entitled “Method and Apparatus for Detecting Item Substitutions During Entry of an Item into a Self-Service Checkout Terminal” by Dusty Lutz, which was issued on Sep. 14, 1999; U.S. Pat. No. 5,747,784 entitled “Method and Apparatus for Providing Security for a Self-Service Checkout Station” by Joanne Walter and Tracy Flynn, which was issued on May 5, 1998; U.S. Pat. No. 6,080,9384 entitled “Method and Apparatus for Resetting a Product Scale of a Retail Checkout Terminal” by Dusty Lutz, which was issued on Jun. 27, 2000; U.S. Pat. No. 6,056,087 entitled “Method and Apparatus for Providing Security to a Self-Service Checkout Terminal” by John Addy and Jim Morrison, which was issued on May 2, 2000; U.S. Pat. No. 6,105,866 entitled “Method and Apparatus for Reducing Shrinkage During Operation of a Self-Service Checkout Terminal” by Jim Morrison and Joanne Walter, which was issued on Aug. 22, 2000; U.S. Pat. No. 6,032,128 entitled “Method and Apparatus for Detecting Item Placement and Item Removal During Operation of a Self-Service Checkout Terminal” by Jim Morrison and Dusty Lutz, which was issued on Feb. 29, 2000; U.S. Pat. No. 6,167,381 entitled “Self-Service Checkout Terminal” by Stephen Swaine, Ali Vassigh, and Grant Paton, which was issued on Oct. 12, 1999; and U.S. Pat. No. 5,965,861 entitled “Method and Apparatus for Enhancing Security in a Self-Service Checkout Terminal” by John Addy and Marc Lynn, which was issued on Oct. 12, 1999. The disclosures of each of the above-identified issued patents and patent applications are hereby specifically incorporated herein by reference in their entireties, and are assigned to the same assignee as the present invention.

As described above, once an intervention-needed activity has been detected, the status tri-light device 78 is operated to summon retail personnel. For example, the status tri-light device 78 may display a first colored light in order to notify retail personnel that intervention is needed prior to the end of the current checkout transaction. Alternatively, the status tri-light device 78 may display a second colored light in order to notify retail personnel that intervention is needed immediately.

The interactive customer interface terminal 66 includes a display monitor 66a which is provided to display retail information to the customer during operation of the checkout system. For example, transaction information such as item price, item description, total amount of the transaction, instructions, etcetera is displayed to the customer via the display monitor 66a during operation of the checkout system. Also displayed on the display monitor 66a are instructions which assist or otherwise guide the customer through operation of the checkout system. Moreover, customer-specific messages may be displayed to the customer on the display monitor 66a at certain times during a checkout transaction.

The display monitor 66a is preferably a known touch screen monitor which can generate data signals when certain areas of the screen are touched by a customer. Hence, the display monitor 66a may be utilized by the customer to input information into the checkout system. For example, the customer may manually enter retail information such as item codes and quantities into the checkout system by use of the touch screen associated with the display monitor 66a. The customer may indicate his or her preferred method of payment (e.g., cash, credit, or debit card) by touching the appropriate area of the touch screen associated with the display monitor 66a. A portion of the touch screen associated with the display monitor 66a may also be utilized as a “help button” such that assistance is provided to the customer when it is touched by the customer.

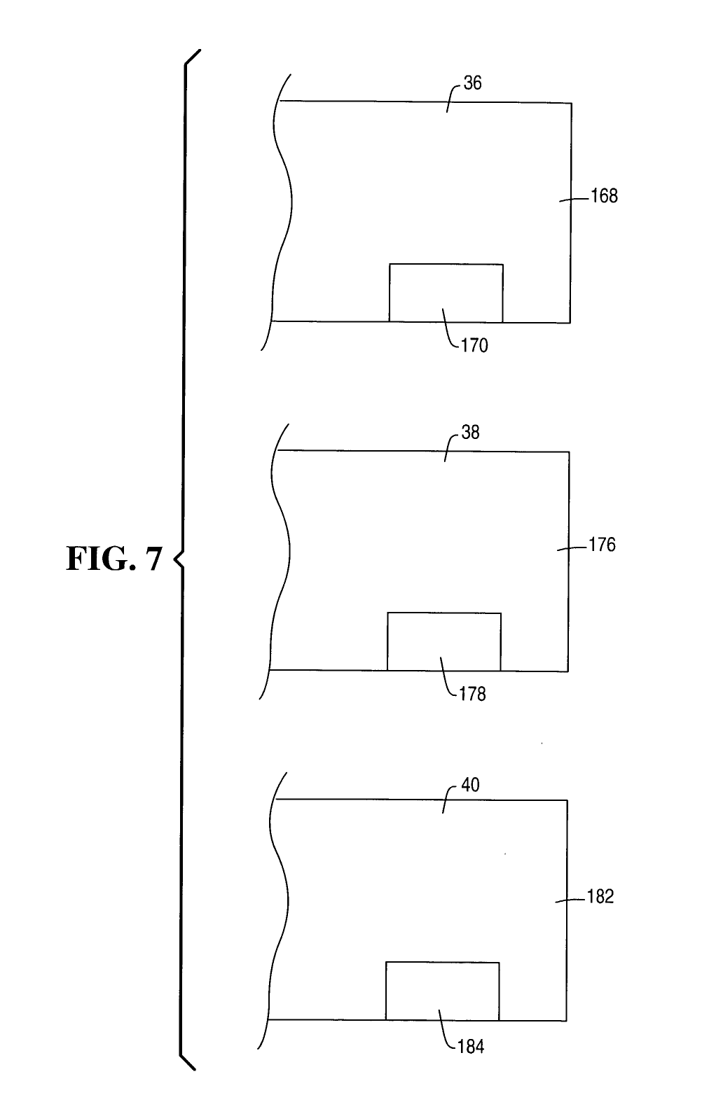

Moreover, the interactive customer interface terminal 66 is preferably embodied as a stand-alone, kiosk-type device which is, in essence, a modified flat panel personal computer (PC) which includes a number of components commonly associated therewith such as a processing unit 66b having a microprocessor 66c (see FIG. 6) and a number of memory modules 66d (see FIG. 9) associated therewith, along with other commonly utilized PC components such as an Ethernet controller, a number of video and audio control devices, a storage memory device such as a hard drive device, and a number of connector ports for coupling the interface terminal 66 to a number of retail peripheral devices such as the scanner 68 and the product scale 70. Hence, in addition to displaying transaction information to the customer, the interactive customer interface terminal 66 functions as the main processing device or controller for controlling operation of the checkout system. It should be appreciated that the interactive customer interface terminal 66 may be embodied as any stand-alone, kiosk-type device which includes the aforedescribed components (e.g., a display monitor, PC, etcetera). One such stand-alone, kiosk-type device which is particularly useful as the interactive customer interface terminal of the present invention is an Informa model information terminal which is commercially available from NCR Corporation.

The scanner 68 conventionally scans or reads a product identification code such as a Universal Product Code (UPC), industrial symbol(s), alphanumeric character(s), or other indicia associated with an item to be purchased. One scanner which may be used in the present invention is a model number 7875 bi-optic scanner which is commercially available from NCR Corporation of Dayton, Ohio.

The scanner 68 includes a first scanning window 68a and a second scanning window 68b. The first scanning window 68a is disposed in a substantially horizontal manner, whereas the second scanning window 68b is disposed in a substantially vertical manner, as shown in FIG. 2. More specifically, the core module cabinet 76 has a substantially horizontal upper surface 80. As shown in FIG. 1, the horizontal scanning window 68a is disposed in a relatively flush-mount arrangement with the upper surface 80 of the core module cabinet 76. Moreover, the product scale 70 is integrated with the scanner 68. More specifically, the product scale 70 is disposed substantially parallel to the upper surface 80 of the core module cabinet 76 and hence the horizontal scanning window 68a thereby enveloping the horizontal scanning window 68a. If an item such as produce is placed upon the product scale 70 or the horizontal scanning window 68a, the product scale 70 may be used to determine the weight of the item.

The scanner 68 also includes a light source (not shown) such as a laser, a rotating mirror (not shown) driven by a motor (not shown), and a mirror array (not shown). In operation, a laser beam reflects off the rotating mirror and mirror array to produce a pattern of scanning light beams. As the product identification code on an item is passed over the scanner 68, the scanning light beams scatter off the code and are returned to the scanner 68 where they are collected and detected. The reflected light is then analyzed electronically in order to determine whether the reflected light contains a valid code pattern. If a valid code pattern is present, the product identification code may then be utilized to retrieve product information associated with the item (e.g., the price of the item). The core module cabinet 76 provides a body for the core module 26 and encases the scanner 68, the product scale 70 and the bill dispenser 72. The lane light assembly 64 and the customer interface terminal 66 are permanently attached to the core module cabinet 76. The core module cabinet includes side walls 48a and 48b. The side wall 48b includes knockouts or throughholes 82b, 83b through which cabling can be routed. For example, cabling to the pedestal 32 can be routed through the knockout 82b. Cabling to a security activation module 186, which will be discussed in detail below, can be routed through the knockout 83b.

What is meant herein by the term “knockout” is a section of a cabinet that is surrounded by perforations such that the section can be easily removed from the cabinet to thereby create a throughhole in the cabinet for routing cabling therethrough. If there is not a need for a throughhole in the area of the knockout, the knockout is not removed, but rather is left attached to the cabinet to thereby preserve the aesthetic appeal of the cabinet.

The back bumper 28 is attached to the back surfaces of the core module cabinet 76 and the pedestal 32, and is configured to prevent shopping carts from running into the core module 26 and the pedestal 32. Thus, the back bumper 28, similarly to the side bumper 20, absorbs the impact of any such errant carts, thereby avoiding dents and scratches in the core module 26 and the pedestal 32.

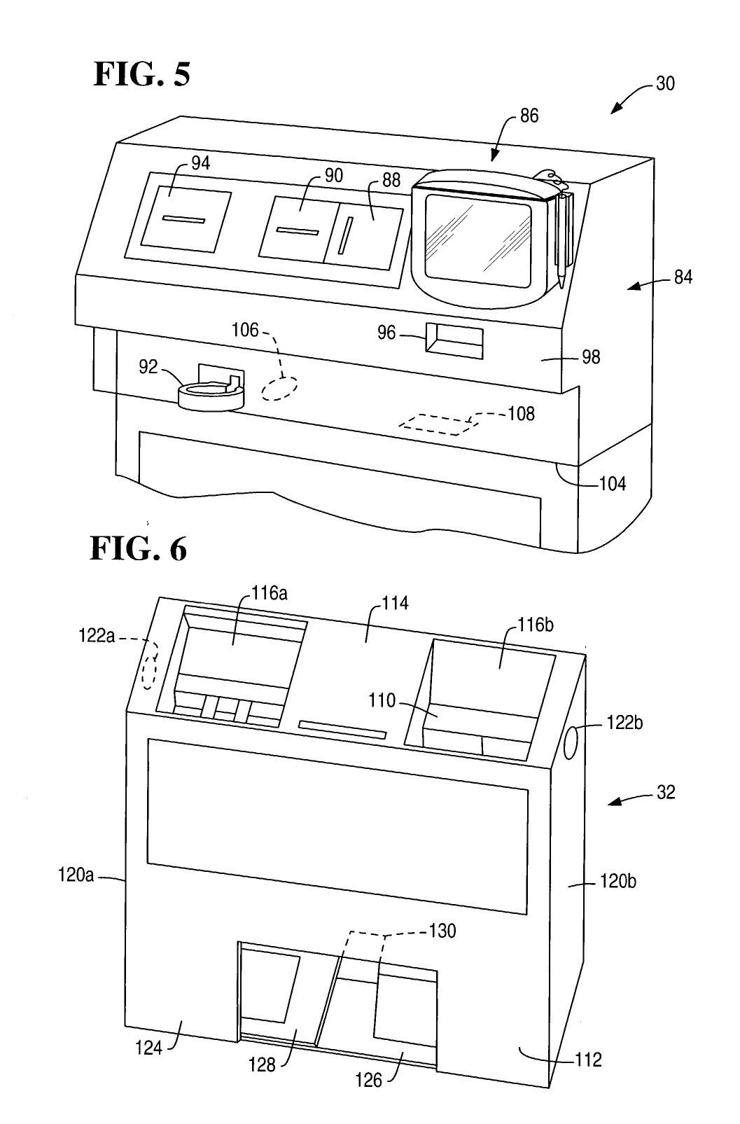

The currency module 30 includes a payment area 84 (see FIG. 5) having the system components necessary to allow a customer to perform retail finalization functions such as tendering payment for his or her items for purchase and printing of transaction receipts. In particular, the payment area 84 of the checkout system includes an electronic payment terminal 86 having a card reader and keypad, a pair of currency acceptors such as a coin acceptor 88 and a bill acceptor 90, a coin dispenser 92, a coupon acceptor 94 and a receipt dispenser 96.

The system components associated with the payment area 84 of the checkout system are provided to allow the customer to tender payment for his or her items for purchase. In particular, once the customer has entered all of his or her items for purchase into the checkout terminal during a self-service checkout transaction, the components associated with the payment area 84 are utilized to complete the self-service checkout transaction by (1) allowing payment to be tendered by either insertion of currency into a currency acceptor (i.e., the coin acceptor 88 and/or the bill acceptor 90), charging a credit card or debit card account, or decreasing a value amount stored on a smart card via the electronic payment terminal 86, and (2) printing a transaction receipt with the receipt dispenser 96. In the case of when a customer inserts currency into the coin acceptor 88 and/or the bill acceptor 90, the checkout system may provide change via a currency dispenser (i.e., the coin dispenser 92 and/or the bill dispenser 72).

The currency module 30 also includes a currency module cabinet 98 providing a body therefor. A bottom wall 104 of the currency module cabinet 98 includes a throughhole 106 through which cabling to the pedestal 32 for a power supply and a hub port can be routed. The bottom wall 104 of the currency module cabinet 98 includes another throughhole 108 through which printer paper from the pedestal 32 is routed for output by the receipt dispenser 96. The currency module cabinet 98 can be attached to the core module cabinet 76, such as by the use of screws and/or nuts and bolts.

The pedestal 32 includes a printer 110 (see FIG. 6) and a pedestal cabinet 112 having a top wall 114 supporting the currency module 30. The top wall 114 includes a throughhole 116a through which cabling to the currency module 30 for a power supply and a hub port can be routed. The top wall 114 also includes another throughhole 116b through which the printer 110 can transport printed paper to the receipt dispenser 96. A side wall 120a of the pedestal cabinet 112 includes a knockout or throughhole 122a through which cabling to the core module 26 can be routed. A front wall 124 of the pedestal cabinet 112 includes a throughhole 126 through which cabling to one of the set 18 of output units can be routed. A bottom wall 128 of the pedestal cabinet 112 includes a throughhole 130 through which cabling running through the floor can be routed. The pedestal cabinet 112 can be attached to the core module cabinet 76 and/or the currency module cabinet 98, such as by the use of screws and/or nuts and bolts.

The base 34 is a substantially flat substrate having a bottom surface 132 contacting the floor and a top surface 134 supporting the core module 26, the pedestal 32 and at least part of the selected one of the set 18 of output units. More particularly, the base 34 supports all of the small bagger 40, part of the large bagger 38, or part of the take-away belt module 36. The base 34 also includes a throughhole 136 aligned with the throughhole 130 in the pedestal 32. Cabling extending between the pedestal 32 and the floor can be routed through the throughhole 136. The base 34 can be attached to the core module cabinet 76, the pedestal cabinet 112, and/or the selected one of the set 18 of output units such as by the use of screws and/or nuts and bolts.

The take-away belt module 36 includes a first take-away belt 138, a second take-away belt 140 arranged in series with the first take-away belt 138, a set of rollers 142, a bagging counter 144, a set aside shelf 146, a take-away belt module cabinet 148 and a base extension 149. The takeaway belts 138, 140 and the rollers 142 are provided to transport items which have been scanned with the scanner 68 or otherwise entered into the checkout system to the bagging counter 144 where the items are placed into grocery bags or the like by the customer or a bagging clerk. Hence, as described herein, the large bagwell 38, the small bagwell 40, and the bagging counter 144 define the three possible bagging stations associated with the checkout system.

The first take-away belt 138 is an endless rotating output belt driven by an electromechanical drive apparatus such as one of the takeaway belt motors (FIG. 9) encased in the take-away belt module cabinet 148. A user places items to be bagged on the upper surface of belt 138, the upper surface being the surface that is visible in FIG. 1. The user generally places the items on an upstream end 150 of the belt 138, and, as the upper surface of the belt 138 rotates in a direction 152, the items are carried from left to right in FIG. 1 toward a downstream end 154 of the belt 138, where the items are transferred to the second take-away belt 140.

The second take-away belt 140, like the first take-away belt 138, is an endless rotating output belt driven by an electromechanical drive apparatus such as one of the take-away belt motors 226 encased in the take-away belt module cabinet 148. Both of the take-away belts 138, 140 can be controlled by and/or powered through the set 16 of main units. The items are transferred from the first take-away belt 138 to an upstream end 156 of the second take-away belt 140 as described above, and, as the upper surface of belt 140 rotates in the direction 152, the items are carried from left to right in FIG. 1 toward a downstream end 158 of the belt 140, where the items are transferred to the set of rollers 142.

The rollers 142 and the bagging counter 144 together define a downward sloping surface on which the items transferred from the second take-away belt 140 slide toward a downstream end 160 of the bagging counter 144. An upstanding wall 162 prevents the further progression of the items off the bagging counter 144. There, at the downstream end 160 of the bagging counter 144 and adjacent to the upstanding wall 162, the items are advantageously positioned for bagging by the customer or a bagging clerk.

Each of the rollers 142 is freely rotatable about its respective central axis. The rollers 142 are caused to rotate by frictional forces imparted by the items that slide across the rollers in the direction 152. The free rotation of the rollers 142 promotes the movement of the items in the direction 152.

The take-away belt module 36 also includes a security scale 164 disposed within the loop defined by the first take-away belt 138. The security scale 164 is a weight scale which monitors the weight of items placed on the first take-away belt 138. The security scale 164 is utilized to provide security by monitoring item movement onto and off of the first take-away belt 138 during a checkout transaction.

The take-away belt module 36 also includes a security deactivation device 166 disposed within the loop defined by the second take-away belt 140. The security deactivation device 166 is provided to deactivate or otherwise disable security tags associated with an electronic article surveillance (EAS) system. In particular, certain items sold by the retailer may have an electronic tag secured thereto. Such electronic tags are generally a label or “clip-on” mechanism which has an electronic transponder imbedded therein which triggers an alarm if the item is taken from the retailer's store without the tag being deactivated or otherwise disabled beforehand. It should be appreciated that such tags are generally secured to items that are expensive in nature, but as the cost associated with such electronic tags continues to decrease, more and more items associated with a given retail operation may be equipped with such electronic tags.

In any event, the electronic tags associated with EAS systems are deactivated by exposing the tag to a magnetic field or an electromagnetic field such as an RF field. The security deactivation device 166 of the present invention generates such a magnetic field or electromagnetic field during operation of the checkout system so as to deactivate electronic tags associated with items for purchase after the items are scanned with the scanner 24. In particular, the security deactivation device 166 generates a deactivation field (e.g., a magnetic and/or electromagnetic field) downstream from a scanner detection zone associated with the scanner 68. What is meant herein by the term “scanner detection zone” is the area proximate the scanning windows 68a, 68b of the scanner 68 which defines the maximum range in which an item can be successfully scanned as it is passed across the scanner 68. Security deactivation devices which are suitable for use as the security deactivation device 166 of the present invention are commercially available from Checkpoint Systems, Incorporated of Thorofare, N.J. (in the case of an RF field generator) and Sensormatic Electronics Corporation of Boca Raton, Fla. (in the case of a magnetic field generator).

By generating the deactivation field downstream from the scanner detection zone, the item is caused to be advanced through the deactivation field, thereby deactivating the electronic security tag secured to the item, only after the item has been scanned. By “automatically” deactivating the electronic security tag after the item has been scanned by a customer (i.e., deactivating the tag during a scanning motion), the customer is not required to perform additional operations for the sole purpose to deactivating the tag prior to exiting the store. In particular, heretofore designed self-service checkout systems have required the customer to take his or her items for purchase to a centralized area such as a terminal operated by a retail clerk after the customer has completed his or her transaction in order to allow the clerk to determine which of the customer's items contain electronic security tags that need to be deactivated. Thereafter, the clerk manually deactivates each of the electronic security tags associated with the customer's items for purchase. It should be appreciated that the extra step of requiring the customer to take his or her items to the centralized area to deactivate the electronic security tags adds cost to the retailer's operation (e.g., the cost associated with staffing the centralized area with a retail clerk) and also creates an inconvenience for the customer by requiring the customer to spend additional time in the retailer's store. Such an inconvenience to the customer is augmented if a line or queue is present at the centralized area.

Utilization of the security deactivation device 166 of the present invention solves such shortcomings of heretofore self-service checkout systems by deactivating the electronic security tag as part of routine entry of items into the checkout system by the customer. In particular, utilization of the security deactivation device 166 eliminates the need for the retail clerk to intervene into the customer's transaction, thereby reducing labor costs associated with the retailer's operation, and also increasing convenience to the customer by not requiring him or her to stand in a potentially long line or queue. Moreover, by generating the deactivation field downstream from the scanner detection zone such that the electronic security tag is deactivated as a result of an item being transferred onto the second take-away belt 140, the customer is not required to operate a separate deactivation device such as a magnetic pad or the like, thereby reducing the number of components with which a customer is presented during operation of the checkout system operation.

It should be appreciated that the security deactivation device 166 may be configured to continuously generate the deactivation field (e.g., the magnetic or electromagnetic field), or may only generate the deactivation field once the product code associated with the item has been captured by the scanner 68. In particular, under the premise that the customer will make a second attempt to scan the item after he sees that the first attempt has failed, i.e., the customer will not try to commit an impropriety such as theft, the security deactivation device 166 may be configured to continuously generate the deactivation field such that the electronic security tag is deactivated irrespective of whether or not the product code associated with the item is actually captured with the scanner 68. For example, if the customer attempts to scan the item with the scanner 68 (by advancing the item through the scanner detection zone with the bar code associated with the item facing one of the scanning windows 68a, 68b), but the product code is not captured by the scanner 68 for any reason, the security deactivation device 166, if configured to continuously produce the deactivation field, causes the electronic security tag to be deactivated even though the item was not actually entered in the checkout system. However, in the case of operation of the checkout system by an honest customer, such premature deactivation of the security tag is not an issue once the customer is subsequently successful at entering the item (e.g., by re-scanning the item or manually entering the product code). It should be appreciated that the customer is likely to perform such re-scanning or manual entry of the item since the customer is not generally made aware of the fact that the electronic security tag has been deactivated.

However, to prevent the unlikely occurrence that the electronic security tag is prematurely deactivated without the item being subsequently entered in the checkout system, the security deactivation device 166 may be configured to generate the deactivation field only after the product code associated with the item has been entered into the checkout system. In particular, a control signal is generated when a product code associated with an item is captured by the scanner 68. In response to generation of such a control signal, the security deactivation device 166 may be actuated so as to generate a deactivation field thereby deactivating the electronic security tag associated with the scanned item. In such a configuration, the location, width, and/or shape of the deactivation field generated by the security deactivation device 166 may be configured to ensure that the item is advanced therethrough during a handling motion subsequent to the scanning motion (e.g., the motion associated with placement of the item onto the take-away belt module 36.

The set-aside shelf 146 is provided to allow a user of the system to set an item aside once the item has been scanned or otherwise entered into the system, but prior to placing the item into a grocery bag. For example, if a customer scans a loaf of bread, the customer may want to place the bread onto the set-aside shelf 146 until one of the grocery bags is nearly full, thereby preventing the bread from being crushed.

As discussed above, the security scale 164 may be utilized to provide security to the checkout system during operation thereof. In particular, the security scale 164 is utilized to monitor the placement of items onto and the removal of items off of the first take-away belt 138. Such item movement monitoring may be utilized to determine if the customer is unintentionally or intentionally committing an impropriety such as theft. For example, a control signal is generated when the scanner 68 successfully captures a product code associated with an item being entered into the checkout system. The security scale 164 may be used to detect placement of an item onto the first take-away belt 138 prior to generation of the control signal thereby enabling detection of the situation in which an unscanned item has been placed on the bagging counter 144 or on the set-aside shelf 146.

Moreover, when an item is scanned with the scanner 68 and thereafter placed on the first take-away belt 138, the detected weight of the item (as detected by the security scale 164) may be compared to a known weight value of the item that is stored in a database in order to confirm that a different, more expensive item was not substituted for the scanned item. It should be appreciated that the database may be in the form of a master database which includes every item sold by the retailer, or may be a “transaction level” database which is constructed locally at the checkout system during operation thereof.

It should be appreciated that a number of security schemes utilizing the security scale 164 may be employed during operation of the checkout system. Examples of security schemes utilizing a security scale that is somewhat similar to the security scale 164 in a self-service checkout system are disclosed in U.S. Pat. No. 5,952,642 entitled “Method and Apparatus for Detecting Item Substitutions During Entry of an Item into a Self-Service Checkout Terminal” by Dusty Lutz, which was issued on Sep. 14, 1999; U.S. Pat. No. 6,032,128 entitled “Method and Apparatus for Detecting Item Placement and Item Removal During Operation of A Self-Service Checkout Terminal” by Jim Morrison and Dusty Lutz, which was issued on Feb. 29, 2000; and U.S. Pat. No. 5,967,264 entitled “Method of Monitoring Item Shuffling in a Post-Scan Area of a Self-Service Checkout Terminal” by Dusty Lutz, Chris Malchak, Tim Mason, Ali Vassigh, which was issued on Oct. 19, 1999. The disclosures of the above-identified issued patents are hereby specifically incorporated herein by reference in their entireties, and are assigned to the same assignee as the present invention.

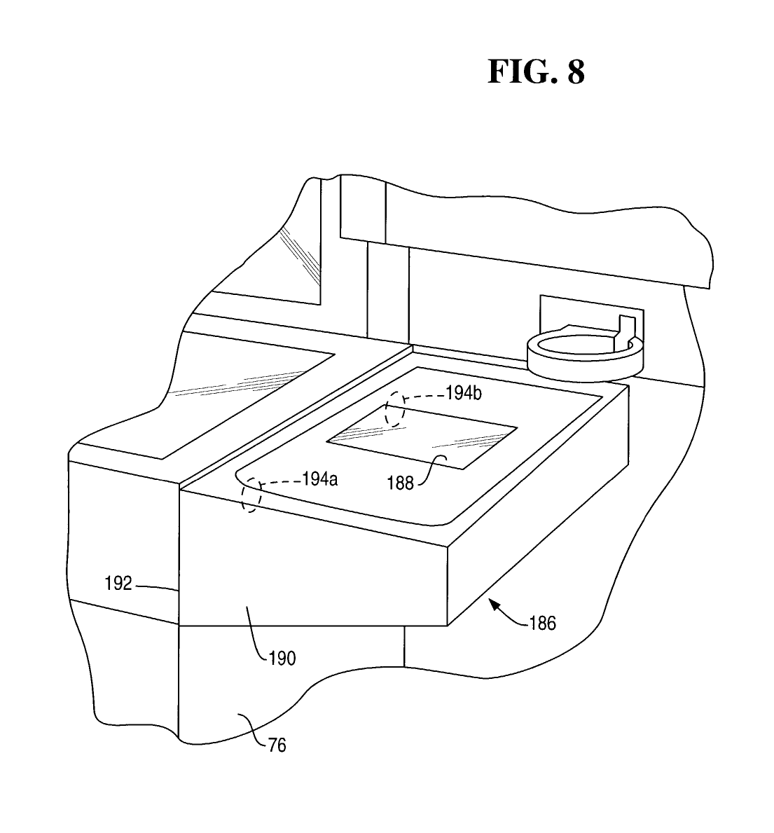

The take-away belt module cabinet 148 substantially surrounds and encases the components of the take-away belt module 36. A back wall 168 (FIG. 7) of the cabinet 148 includes a knockout or throughhole 170 through which cabling to the pedestal 32 can be routed.

The base extension 149 supports a portion of the take-away belt module 36 that is not supported by the base 34. When the take-away belt module 36 is assembled with the set 16 of main units, the base extension 149 abuts the base 34 to provide seamless support for the take-away belt module 36.

The large bagwell 38 and the small bagwell 40 are provided to accommodate one or more grocery containers such as the grocery bags 46. In particular, the large bagwell 38 is configured to allow three of the grocery bags 46 to be accessed by the customer at any given time thereby allowing a customer to selectively load various item types into the grocery bags during operation of the checkout system. For example, during a self-service checkout transaction, the customer may desire to use a first grocery bag for household chemical items such as soap or bleach, a second grocery bag for refrigerated edible items such as meat and dairy items, and a third grocery bag for non-refrigerated edible items such as canned goods in order to keep the three types of items separate. In addition to the bagging areas, the large bagwell 38 includes an end area 172 for receiving items that are too bulky or heavy to be bagged, such as a case of beer.

The large bagwell 38 includes a large bagwell cabinet 174 substantially surrounding and encasing the large bagwell 38, and a bumper 175 mounted on the cabinet 174. The large bagwell cabinet 174 includes a back wall 176 having a knockout or throughhole 178 through which cabling to the pedestal 32 can be routed.

The large bagwell 38 also includes a base extension 179 supporting a portion of the large bagwell 38 that is not supported by the base 34. When the large bagwell 38 is assembled with the set 16 of main units, the base extension 179 abuts the base 34 to provide seamless support for the large bagwell 38.

The small bagwell 40 is configured to allow two of the grocery bags 46 to be accessed by the customer at any given time thereby allowing a customer to selectively load various item types into the grocery bags during operation of the checkout system. For example, during a self-service checkout transaction, the customer may desire to use a first grocery bag for household chemical items such as soap or bleach, and a second grocery bag for edible items such as meat and produce in order to keep the two types of items separate.

The small bagwell 40 includes a small bagwell cabinet 180 substantially surrounding and encasing the small bagwell 40, and a bumper 181 mounted on the cabinet 180. The small bagwell cabinet 180 includes a back wall 182 having a knockout or throughhole 184 through which cabling to the pedestal 32 can be routed. Such a two-bag configuration of the small bagwell 40 is particularly useful when the checkout system is being operated to perform an “express” checkout transaction in which the total number of items for purchase in the transaction is relatively small and can therefore be bagged in a small number of grocery bags.

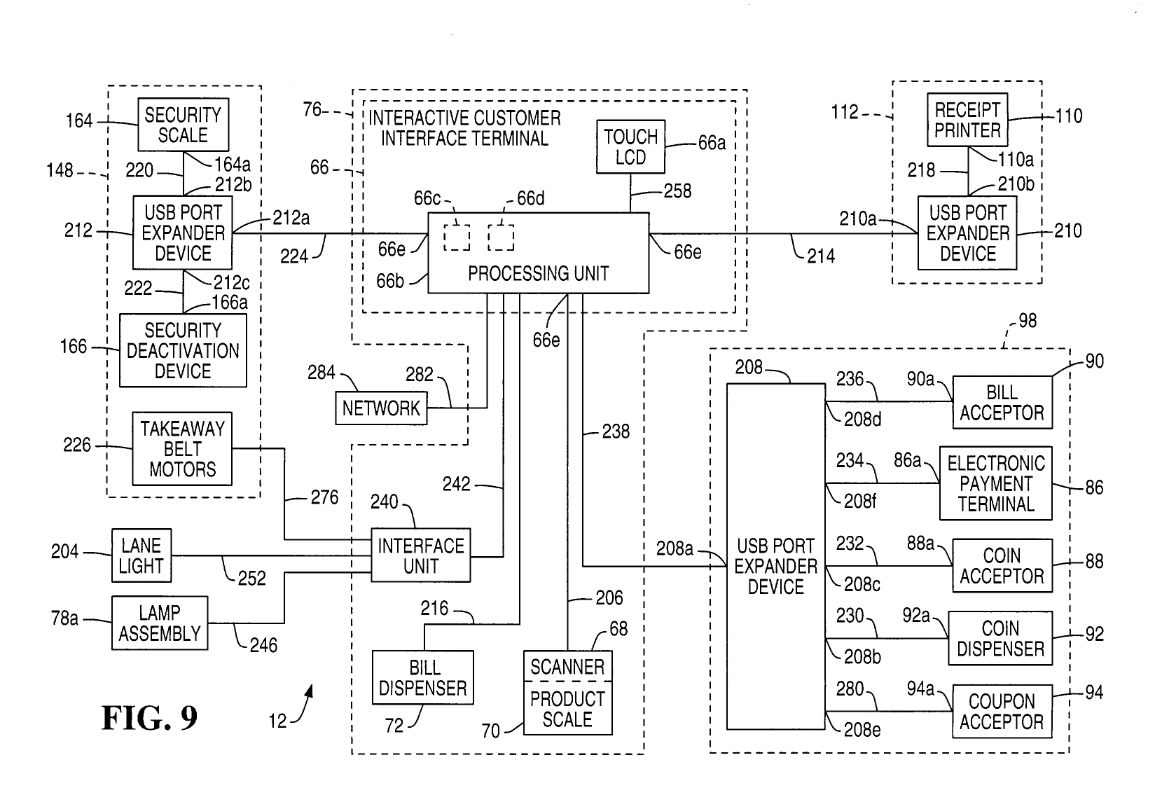

The large bagwell 38 and the small bagwell 40 do not include a security deactivation device, such as the security deactivation device 166 of the take-away belt module 36. Thus, in configurations of the checkout system that include either the large bagwell 38 or the small bagwell 40, a security deactivation module 186 (see FIG. 3) may be included. The security deactivation module 186 includes a security deactivation device 188 (FIG. 8) and a security deactivation cabinet 190 that supports and encases the security deactivation device 188. The security deactivation cabinet 190 is attached to the core module cabinet 76 and includes a side wall 192 having a throughhole or knockout 194b through which cabling can be routed to the knockout 83b of the core module cabinet 76.

The security deactivation device 188 of the present invention generates such a magnetic field or electromagnetic field during operation of the checkout system so as to deactivate electronic tags associated with items for purchase as the items are scanned with the scanner 68. In particular, the security deactivation device 188 generates a deactivation field (e.g., a magnetic and/or electromagnetic field) proximate to a scanner detection zone associated with the scanner 68. What is meant herein by the term “scanner detection zone” is the area proximate the scanning windows 68a, 68b of the scanner 68 which defines the maximum range in which an item can be successfully scanned as it is passed across the scanner 68. Security deactivation devices which are suitable for use as the security deactivation device 188 of the present invention are commercially available from Checkpoint Systems, Incorporated of Thorofare, N.J. (in the case of an RF field generator) and Sensormatic Electronics Corporation of Boca Raton, Fla. (in the case of a magnetic field generator).

By generating the deactivation field proximate to the scanner detection zone, a scanning motion utilized to scan an item with the scanner 68 causes the item to be advanced through the deactivation field thereby deactivating the electronic security tag secured to the item in the same scanning motion. In particular, by “automatically” deactivating the electronic security tag when the item is being scanned by a customer (i.e., deactivating the tag during a scanning motion), the customer is not required to perform additional operations for the sole purpose to deactivating the tag prior to exiting the store. In particular, heretofore designed self-service checkout systems have required the customer to take his or her items for purchase to a centralized area such as a terminal operated by a retail clerk after the customer has completed his or her transaction in order to allow the clerk to determine which of the customer's items contain electronic security tags that need to be deactivated. Thereafter, the clerk manually deactivates each of the electronic security tags associated with the customer's items for purchase. It should be appreciated that the extra step of requiring the customer to take his or her items to the centralized area to deactivate the electronic security tags adds cost to the retailer's operation (e.g., the cost associated with staffing the centralized area with a retail clerk) and also creates an inconvenience for the customer by requiring the customer to spend additional time in the retailer's store. Such an inconvenience to the customer is augmented if a line or queue is present at the centralized area.

Utilization of the security deactivation device 188 of the present invention solves such shortcomings of heretofore self-service checkout systems by deactivating the electronic security tag as part of routine entry of items into the checkout system by the customer. In particular, utilization of the security deactivation device 188 eliminates the need for the retail clerk to intervene into the customer's transaction thereby reducing labor costs associated with the retailer's operation, along with increasing convenience to the customer by not requiring him or her to stand in a potentially long line or queue. Moreover, by generating the deactivation field proximate to the scanner detection zone such that the electronic security tag is deactivated as a result of an item scanning motion, the customer is not required to operate a separate deactivation device such as a magnetic pad or the like thereby reducing the number of components that a customer is presented with during operation of the checkout system.

It should be appreciated that the security deactivation device 188 may be configured to continuously generate the deactivation field (e.g., the magnetic or electromagnetic field), or may only generate the deactivation field once the product code associated with the item has been captured by the scanner 68. In particular, under the premise that if the customer is making an attempt to scan the item, the customer is likely not trying to commit an impropriety such as theft, the security deactivation device 188 may be configured to continuously generate the deactivation field such that the electronic security tag is deactivated irrespective of whether or not the product code associated with the item is actually captured with the scanner 68. For example, if the customer attempts to scan the item with the scanner 68 (by advancing the item through the scanner detection zone with the bar code associated with the item facing one of the scanning windows 68a, 68b), but the product code is not captured by the scanner 68 for any reason, the security deactivation device 188, if configured to continuously produce the deactivation field, causes the electronic security tag to be deactivated even though the item was not actually entered in the checkout system. However, in the case of operation of the checkout system by an honest customer, such premature deactivation of the security tag is not an issue once the customer is subsequently successful at entering the item (e.g., by re-scanning the item or manually entering the product code). It should be appreciated that the customer is likely to perform such re-scanning or manual entry of the item since the customer is not generally made aware of the fact that the electronic security tag has been deactivated.

However, to prevent the unlikely occurrence that the electronic security tag is prematurely deactivated without the item being subsequently entered in the checkout system, the security deactivation device 188 may be configured to generate the deactivation field only after the product code associated with the item has been entered into the checkout system. In particular, a control signal is generated when a product code associated with an item is captured by the scanner 68. In response to generation of such a control signal, the security deactivation device 188 may be instantaneously actuated so as to generate a deactivation field thereby deactivating the electronic security tag associated with the scanned item. In such a configuration, the location, width, and/or shape of the deactivation field generated by the security deactivation device 188 may be configured to ensure that the item is advanced therethrough during a scanning motion or subsequent handling motion (e.g., the motion associated with placement of the item onto the large bagwell 38 or the small bagwell 40).

As discussed above, the checkout system may be configured in any of nine different configurations. More particularly, the checkout system may include any one of the three input units from the terminal configuration kit 10 (i.e., the side bumper 20, the input belt module 22 and the basket shelf 24), and, for each of these three input units, any one of the three output units (i.e., the take-away belt module 36, the large bagwell 38 and the small bagwell 40) from the terminal configuration kit 10 may be included. Further, for any configuration including the large bagwell 38 or the small bagwell 40, the security deactivation module 186 may or may not be included.

Each of the side bumper 20, the input belt module 22 and the basket shelf 24 can be attached to the side surface 48a of the core module cabinet 76 by screws, nuts and bolts, or by any other suitable non-permanent means. Similarly, each of the upper currency module 30, the pedestal 32, and the side surface of one of the output units (i.e., the take-away belt module 36, the large bagwell 38 and the small bagwell 40) can be attached to the side surface 48b of the core module cabinet 76 by screws, nuts and bolts, or by any other suitable non-permanent means.

The base 34 can be attached to the bottom surface of the core module cabinet 76, the bottom wall 128 of the pedestal cabinet 112, and the bottom surface of one of the output units (i.e., the take-away belt module 36, the large bagwell 38 and the small bagwell 40) via nuts and bolts or via any other suitable non-permanent means.

The core module 26, the upper currency module 30, the pedestal 32, the base 34 and one of the output units (i.e., the take-away belt module 36, the large bagwell 38 and the small bagwell 40) are attached together such that their knockouts or throughholes are in alignment so that cabling can be easily routed therethrough even when adjacent ones of the components are abutting each other. More particularly, when a terminal is assembled from the terminal configuration kit 10, the throughhole 82b of the core module cabinet 76 is aligned with the throughhole 122a of the pedestal 32; the throughhole 116a of the pedestal cabinet 112 is aligned with the throughhole 106 of the currency module cabinet 98; the throughhole 116b of the pedestal cabinet 112 is aligned with the throughhole 108 of the currency module cabinet 98; and the throughhole 130 of the pedestal cabinet 112 is aligned with the throughhole 136 in the base 34. Moreover, if the security deactivation module 186 is included, the throughhole 83b of the core module cabinet 76 is aligned with the throughhole 194b of the security deactivation cabinet 190. Further, the throughhole 126 of the pedestal cabinet 112 is aligned with one of the throughhole 170 of the take-away belt module cabinet 148, the throughhole 178 of the large bagwell cabinet 174, and the throughhole 184 of the small bagwell cabinet 180.

An assembled checkout terminal, such as the checkout terminal 12 (see FIG. 2) for example, includes a pre-scan area 196 defined by one of the set 14 of input units; an itemization area 198 defined by the core module 26; a payment area 84 defined by upper currency module 30; and a post-scan area 200 defined by one of the set 18 of output units. In particular, an item enters at the area proximate the pre-scan area 196 then flows in a downstream direction to be scanned or otherwise entered at the itemization area 198. Once the item is scanned or otherwise entered at the itemization area 198, the item flows from the itemization area 198 in a downstream direction to the post-scan area 200.

Of the nine possible combinations from the set 14 of input units and the set 18 of output units (i.e., the three different possible output units 36, 38, 40 for each of the three inputs units 20, 22, 24), only the combination represented by the checkout terminal 12 of FIG. 2 will be described herein in detail in order to avoid excessive repetition. However, it is to be understood that the description of the structure, operation and advantages of the checkout terminal 12 as stated herein can, where applicable, also be extended to each of the other eight possible combinations of the components of the terminal configuration kit 10, such as, for example, the checkout terminal 44 of FIG. 3.

Referring now to FIG. 9, there is shown a simplified block diagram of the checkout system 12 of FIG. 2. In addition to the display monitor 66a, the processing unit 66b of the interactive customer interface terminal 66 is electrically coupled to the scanner 68, the product scale 70, the electronic payment terminal 86, the coin acceptor 88, the bill acceptor 90, the coin dispenser 92, the bill dispenser 72, the receipt printer 110, the security scale 164, the status tri-light device 78, and the security deactivation device 166. The processing unit 66b is also electrically coupled to a signature capture device 202 and a lane light 204.

The processing unit 66b monitors output signals generated by the assembly of the scanner 68 and the product scale 70 via a serial data communication line 206 (e.g., an RS-232 serial data cable). In particular, when the customer scans an item which includes a product identification code across the scanning windows 68a, 68b, an output signal indicative of the product identification code is generated on the data communication line 206. Similarly, when a customer places an item on the product scale 70, the product scale 70 generates an output signal on the data communication line 206 which is indicative of the weight of the item.

The processing unit 66b communicates with the bill dispenser 72 via a serial data communication line 216 (e.g., an RS-232 serial data cable). In particular, the processing unit 66b communicates with the bill dispenser 72 in order to dispense change in the form of bills to a customer during finalization of a checkout transaction. In particular, when a customer is owed change in the form of bills during finalization of a checkout transaction, the processing unit 66b generates an output signal indicative of the amount of change in the form of bills that is owed the customer. Such an output signal is communicated to the bill dispenser 72 thereby causing the bill dispenser 72 to dispense the correct amount of change in the form of bills to the customer.

The checkout system 12 also includes a number of port expander devices 208, 210, 212. The port expander devices 208, 210, 212 may be any known port expander device which enables a number of communication lines (e.g., data cables) to be connected to a single port of a controller (e.g., the connector ports associated with the interactive customer interface terminal 66). Moreover, the port expander devices 208, 210, 212 of the present invention preferably allow more than one interface type. For example, the port expander devices 208, 210, 212 of the present invention are preferably coupled to the processing unit 66b of the interactive customer interface terminal 66 via a Universal Serial Bus (USB) interface, but are coupled to certain retail peripheral devices (e.g., the electronic payment terminal 86, or the security scale 164) via an RS-232 serial interface. Such a configuration is particularly useful since commercially available retail devices are typically configured to communicate with a controller via an RS-232 serial interface thereby allowing the checkout system 12 to be configured with “industry standard” retail peripheral devices as opposed to more expensive, proprietary devices. It should be appreciated that in addition to USB/RS-232 port expander devices, other types of port expander devices may also be utilized in the present invention. For example, port expander devices which are coupled to the processing unit 66b via an Ethernet interface (i.e., an Ethernet/RS-232 port expander device) may also be utilized in the present invention.

As utilized in construction of the checkout system 12, the port expander devices 208, 210, 212 facilitate the coupling of a number of retail peripheral devices associated with the system 12 to the processing unit 66b of the interactive customer interface terminal 66. In particular, a USB port 210a of the port expander device 210 is coupled to a USB data port 66e of the processing unit 66b via a USB communication line 214 (e.g., a USB data cable).

A serial port 110a of the receipt printer 110 is coupled to a serial port 210b of the port expander device 210 via a serial communication line 218 (e.g., an RS-232 serial data cable). Hence, the processing unit 66b communicates with the receipt printer 110 via a data path that includes the USB communication line 214, the port expander device 210, and the serial communication line 218. In such a manner, the processing unit 66b communicates with the receipt printer 110 in order to generate transaction receipts at the completion of a checkout transaction. The receipt printer 110 may be embodied as any type of ink-jet, laser, dot-matrix, LED, or thermal printer which is capable of printing alphanumeric characters associated with transaction information on a transaction receipt.

Similarly to the port expander device 210, the port expander device 212 is utilized to facilitate communication and control between the processing unit 66b and a number of retail peripheral devices. In particular, a USB port 212a of the port expander device 212 is coupled to the USB data port 66e of the processing unit 66b via a USB communication line 224 (e.g., a USB data cable).

A serial port 164a of the security scale 164 is coupled to a first serial port 212b of the port expander device 212 via a serial communication line 220 (e.g., an RS-232 serial data cable). Hence, the processing unit 66b communicates with the security scale 164 via a data path that includes the USB communication line 224, the port expander device 212, and the serial communication line 220. In such a manner, the processing unit 66b communicates with the security scale 164 in order to (1) monitor the placement of items onto, or the removal of items off of, the first take-away belt 138. In particular, when an item is placed onto the first take-away belt 138, the security scale 164 generates an output signal indicative of the weight of the item which is communicated to the processing unit 66b. Similarly, when an item is removed from the first take-away belt 138, the security scale 164 generates an output signal indicative of the weight of the removed item which is communicated to the processing unit 66b.

A serial port 166a of the security deactivation device 166 is coupled to a second serial port 212c of the port expander device 212 via a serial communication line 222 (e.g., an RS-232 serial data cable). Hence, the processing unit 66b communicates with and controls the security deactivation device 166 via a data path that includes the USB communication line 224, the port expander device 212, and the serial communication line 222. In such a manner, the processing unit 66b communicates with the security deactivation device 166 in order to generate a deactivation field (e.g., a magnetic or electromagnetic field) which deactivates electronic security tags associated with an EAS system. As described above, the security deactivation device 166 may be configured to continuously generate a deactivation field, or alternatively, the processing unit 66b may communicate with the security deactivation device 166 to selectively generate the deactivation field in response to capture of the product code associated with an item being scanned or otherwise entered into the checkout system 12.

Similarly to the port expander devices 210, 212, the port expander device 208 is utilized to facilitate communication between the processing unit 66b and a number of retail peripheral devices. In particular, a USB port 208a of the port expander device 208 is coupled to the USB data port 66e of the processing unit 66b via a USB communication line 238 (e.g., a USB data cable).

A serial port 92a of the coin dispenser 92 is coupled to a first serial port 208b of the port expander device 208 via a serial communication line 230 (e.g., an RS-232 serial data cable). Hence, the processing unit 66b communicates with the coin dispenser 92 via a data path that includes the USB communication line 238, the port expander device 208, and the serial communication line 230. In such a manner, the processing unit 66b communicates with the coin dispenser 92 in order to dispense change in the form of coins to a customer during finalization of a checkout transaction. In particular, when a customer is owed change in the form of coins during finalization of a checkout transaction, the processing unit 66b generates an output signal indicative of the amount of change in the form of coins that is owed the customer. Such an output signal is communicated to the coin dispenser 92 thereby causing the coin dispenser 92 to dispense the correct amount of change in the form of coins to the customer.

A serial port 88a of the coin acceptor 88 is coupled to a second serial port 208c of the port expander device 208 via a serial communication line 232 (e.g., an RS-232 serial data cable). Hence, the processing unit 66b communicates with the coin acceptor 88 via a data path that includes the USB communication line 238, the port expander device 208, and the serial communication line 232. In such a manner, the processing unit 66b communicates with the coin acceptor 88 in order to accept coins from a customer during finalization of a checkout transaction. In particular, when a customer inserts coins into the coin acceptor 88 during finalization of a checkout transaction, the coin acceptor 88 generates an output signal indicative of the value of each coin which is inserted into the coin acceptor 88. Such an output signal is communicated to the processing unit 66b in order to determine if the customer has inserted the requisite amount of currency to tender payment for his or her items for purchase.

A serial port 90a of the bill acceptor 90 is coupled to a third serial port 208d of the port expander device 208 via a serial communication line 236 (e.g., an RS-232 serial data cable). Hence, the processing unit 66b communicates with the bill acceptor 90 via a data path that includes the USB communication line 238, the port expander device 208, and the serial communication line 236. In such a manner, the processing unit 66b communicates with the bill acceptor 90 in order to accept bills from a customer during finalization of a checkout transaction. In particular, when a customer inserts bills into the bill acceptor 90 during finalization of a checkout transaction, the bill acceptor 90 generates an output signal indicative of the value of each bill that is inserted into the bill acceptor 90. Such an output signal is communicated to the processing unit 66b in order to determine if the customer has inserted the requisite amount of currency to tender payment for his or her items for purchase.

A serial port 94a of the coupon acceptor 94 is coupled to a fourth serial port 208e of the port expander device 208 via a serial communication line 280 (e.g., an RS-232 serial data cable). Hence, the processing unit 66b communicates with the coupon acceptor 94 via a data path that includes the USB communication line 238, the port expander device 208, and the serial communication line 280. In such a manner, the processing unit 66b communicates with the coupon acceptor 94 in order to accept coupons from a customer during finalization of a checkout transaction. In particular, when a customer inserts coupons into the coupon acceptor 94 during finalization of a checkout transaction, the coupon acceptor 94 generates an output signal indicative of the presence of the tendered coupon. Such an output signal is communicated to the processing unit 66b in order to confirm that the coupon has been tendered. It should be appreciated that the coupon acceptor 94 may be equipped with a bar code reader or the like to capture machine readable indicia that is printed on certain coupons.

A serial port 86a of the electronic payment terminal 86 is coupled to a fifth serial port 208f of the port expander device 208 via a serial communication line 234 (e.g., an RS-232 serial data cable). Hence, the processing unit 66b communicates with the electronic payment terminal 86 via a data path that includes the USB communication line 238, the port expander device 208, and the serial communication line 234. In such a manner, the processing unit 66b communicates with the electronic payment terminal 86 in order to allow a customer to electronically tender payment for his or her items for purchase via, for example, a debit, credit, or smart card. In particular, as described above, the electronic payment terminal 86 includes a card reader and an input device such as a touch pad. The touch pad associated with the electronic payment terminal 86 may include one or more of a known touch pad or a keypad, whereas the card reader may include a known credit, debit, loyalty, and/or smart card reader which is capable of reading information stored on the customer's card. Hence, the processing unit 66b communicates with the electronic payment terminal 86 in order to receive data read from the customer's card or codes such as PIN numbers which are input by the customer via use of the touch pad.

The electronic payment terminal 86 may include a signature capture device (not shown) in order to create an electronic record of a customer's signature during a credit transaction. In particular, the signature capture device may include any known signature capture device which is capable of generating an electronic representation of a customer's signature when the customer signs his or her name with a pen, stylus, or other writing instrument associated with the signature capture device. Capturing a customer's signature with a signature capture device generally causes the retailer to be charged a smaller transaction fee for the credit card transaction from the bank or other financial institution which issued the customer's card. Such lower transaction fees are particularly beneficial in the retail grocery business due to the relatively small profit margins associated with such a business.

It should be appreciated that use of the port expander devices 208, 210, 212 provides the checkout system 12 of the present invention with numerous advantages over heretofore checkout systems. For example, use of the port expander devices 208, 210, 212 allows the processing unit 66b associated with the interactive customer interface terminal 66 to be configured with a relatively small number of output connectors. For example, if not for use of the port expander devices 208, 210, 212, a connector would have to be provided on the processing unit 66b for each of the components which are coupled to the port expander devices 208, 210, 212 in FIG. 9 in order to couple the components directly to the output connectors of the processing unit 66b. Such a requirement for additional connector/port capacity would undesirably increase the size and cost of the interactive customer interface terminal 66.

In addition to reducing the number of output connectors that must be provided on the processing unit 66b, use of the port expander devices 208, 210, 212 also simplifies or otherwise enhances the cable management of the checkout system 12. In particular, the port expander devices 208, 210, 212 are preferably located in relatively close proximity to the retail peripheral devices to which the port expander devices 208, 210, 212 are coupled, thereby reducing the distance across which the individual serial cables associated with each peripheral device must be routed. For instance, it is preferable to mount the port expander device 208, 210, 212 within the same module cabinet 98, 112, 148 in which the retail peripheral devices coupled to the port expander devices 208, 210, 212 are disposed.

More specifically, as shown in FIGS. 1 and 9, the port expander device 208 is secured within the currency module cabinet 98 so as to be located in relatively close proximity to the electronic payment terminal 86, the coin acceptor 88, the bill acceptor 90, the coin dispenser 92, and the coupon acceptor 94. In such a configuration, the serial cables respectively associated with each of the devices 86, 88, 90, 92, and 94 (i.e., the serial communication lines 234, 232, 236, 230, 280, respectively) are completely contained within the currency module cabinet 98. What is meant herein by the term “completely contained” in regard to cables is that the entire cable is positioned within a structure (e.g., one of the module cabinets 98, 112, 148) such that no portion of cable extends out of the structure. Hence, in regard to the port expander device 208, only the USB cable (i.e., the USB communication line 238) must be routed outside of the currency module cabinet 98. In particular, a first end connector of the cable associated with the USB communication line 238 is secured to the USB port 66e of the processing unit 66b, whereas a second end connector of the cable associated with the USB communication line 238 is secured to the USB port 208a of the port expander device 208. Hence, a central portion of the cable associated with the USB communication line 238 is routed or otherwise extends between the core module cabinet 76 and the currency module cabinet 98. However, the USB cable associated with the USB communication line 238 is the only communication cable associated with the devices 86, 88, 90, 92, and 94 that extends out of the currency module cabinet 98.

Similarly to the port expander device 208, the port expander device 210 is secured within the pedestal cabinet 112 so as to be located in relatively close proximity to the receipt printer 110. In such a configuration, the serial cable associated with the printer 110 (i.e., the serial communication line 218) is completely contained within the pedestal cabinet 112. Hence, in regard to the port expander device 210, only the USB cable (i.e., the USB communication line 214) must be routed outside of the pedestal cabinet 112. In particular, a first end connector of the cable associated with the USB communication line 214 is secured to the USB port 66e of the processing unit 66b, whereas a second end connector of the cable associated with the USB communication line 214 is secured to the USB port 210a of the port expander device 210. Hence, a central portion of the cable associated with the USB communication line 214 is routed or otherwise extends between the core module cabinet 76 and the pedestal cabinet 112. However, the USB cable associated with the USB communication line 214 is the only communication cable associated with the receipt printer 110 that extends out of the pedestal cabinet 112.

Similarly to the port expander devices 208, 210, the port expander device 212 is secured within the take-away belt module cabinet 148 so as to be located in relatively close proximity to the security scale 164 and the security deactivation device 166. In such a configuration, the serial cables associated with the security scale 164 and the security deactivation device (i.e., the serial communication lines 220 and 222, respectively) are completely contained within the take-away belt module cabinet 148. Hence, in regard to the port expander device 212, only the USB cable (i.e., the USB communication line 224) must be routed outside of the takeaway belt module cabinet 148. In particular, a first end connector of the cable associated with the USB communication line 224 is secured to the USB port 66e of the processing unit 66b, whereas a second end connector of the cable associated with the USB communication line 224 is secured to the USB port 212a of the port expander device 212. Hence, a central portion of the cable associated with the USB communication line 224 is routed or otherwise extends between the core module cabinet 76 and the take-away belt module cabinet 148. However, the USB cable associated with the USB communication line 224 is the only cable associated with the security scale 164 and the security deactivation device 166 that extends out of the take-away belt module cabinet 148.

It is to be understood that it is within the scope of the present invention for any of the devices that are connected to the processing unit 66b through one of USB port expander devices 208, 210, 212 to instead be directly connected to the processing unit 66b through a serial data communication line (e.g., an RS-232 serial data cable). For example, any one of or each of the electronic payment terminal 86, the coin acceptor 88, the bill acceptor 90, the coin dispenser 92 and the coupon acceptor 94 of the upper currency module 30 could be individually and directly connected to the processing unit 66b without the use of the intervening USB port expander device 208. However, if it is desired to replace the upper currency module 30 with another version of the upper currency module (such as, e.g., an upgraded version or a right-hand version in place of a left-hand version), it would then be necessary to individually disconnect the old version and individually reconnect the new version of each of the electronic payment terminal 86, the coin acceptor 88, the bill acceptor 90, the coin dispenser 92 and the coupon acceptor 94. In contrast, by use of the USB port expander device 208, it would only be necessary to disconnect and reconnect one connection (i.e., at the USB port 208a) when replacing the upper currency module 30 with another version thereof. The processing unit 66b of the interactive customer interface terminal 66 also controls operation of a number of components associated with the checkout system 12 which are not controlled via use of a standard communication protocol (e.g., RS-232). In particular, a number of components associated with the checkout system 12 are “on-off” devices such as the lane light 204, the lamp assembly 78a associated with the status tri-light device 78, and the motors 226 associated with the take-away belts 138, 140. The core module 26 further includes an interface unit 240 for interfacing with such devices. In particular, the interface unit 240 interfaces with the take-away belt motors 226, the lamp assembly 78a of the status light device 78, and the lane light 204. As shown in FIG. 9, the interface unit 240 is coupled to a serial port associated with the processing unit 66b via a serial communication line 242 (e.g., a serial cable).

The take-away belt motors 226 are coupled to the interface unit 140 via a control line 276. Hence, the processing unit 66b controls operation of the take-away belt motors 226 via a data path that includes the serial communication line 242, the interface unit 240, and the control line 276. In such a manner, the processing unit 66b controls actuation of the motors 226 so as to control advancement of the take-away belts 138, 140. In particular, as described above, the takeaway belt motors 226 may be actuated in order to advance items which have been scanned or otherwise entered from the itemization area 198 to the bagging counter 144.

The lamp assembly 78a of the status light device 78 is coupled to the interface unit 240 via a control line 246. Hence, the processing unit 66b controls operation of the lamp assembly 78a via a data path that includes the serial communication line 242, the interface unit 240, and the control line 246. In such a manner, the processing unit 66b controls actuation of the lamps associated with the lamp assembly 78a. In particular, as described above, the lamp assembly 78a is utilized to summon retail personnel to the checkout system 12 in order to provide assistance and/or security during operation of the system 12. Accordingly, the processing unit 66 may cause a red lamp associated with the lamp assembly 78a to be illuminated when intervention by retail personnel is needed immediately, whereas a yellow lamp may be illuminated when intervention is not needed until the end of the customer's transaction. Similarly, a green lamp may be illuminated when the checkout system 12 is being operated properly without the need for intervention by retail personnel.

The lane light 204 is coupled to the interface unit 240 via a control line 252. Hence, the processing unit 66b controls operation of the lane light 204 via a data path that includes the serial communication line 242, the interface unit 240, and the control line 252. In such a manner, the processing unit 66b controls actuation of the lamps associated with the lane light 204. The lane light 204 is utilized to communicate the lane number associated with a given checkout system 12 to retail personnel or customers. In particular, when a particular lamp associated with the lane light 204 is illuminated, the lane number associated with the given checkout system 12 is displayed. Such illumination also communicates that the checkout system 12 is “open” (i.e., available for use by the customer).

The processing unit 66b communicates with the display monitor 66a associated with the interactive customer interface terminal 66 through an internal data bus 258. The processing unit 66b generates output signals on the data bus 258 which cause various messages such as transaction information, instructions, or advertisements to be displayed on the display monitor 66a. As alluded to above, the display monitor 66a may include known touch screen technology which can generate output signals when the customer touches a particular area of the display screen associated with the display monitor 66a. The signals generated by the display monitor 66a are transmitted to the processing unit 66b via the data bus 258.

The processing unit 66b includes network interface circuitry (not shown) which conventionally permits the checkout system 12 to communicate with the retailer's network 284 such as a LAN or WAN through a wired connection 282 (see FIG. 9). The processing unit 66b communicates with the retailer's network 284 during the checkout procedure in order to obtain information, such as pricing information, associated with an item being scanned or otherwise entered, and also to verify customer credit approval when appropriate. The network interface circuitry associated with the checkout system 12 may include a known Ethernet expansion card, and the wired connection 282 may include a known twisted-pair communication line. Alternatively, the network interface circuitry may support wireless communications with the retailer's network 284.

The processing unit 66b also communicates with the retailer's network 284 in order to access a customer profile database maintained in a network memory device such as a network mass storage device (not shown) associated with a network central server (not shown). The customer profile database includes unique, customer-specific retail information associated with each of the retailer's customers. For example, when a customer initially applies or otherwise registers for his or her loyalty card, customer-specific retail information such as name, address, gender, age, account numbers, or other demographic information is generally collected on the customer's application. Such customer-specific retail information is included in the customer's profile within the customer profile database. Moreover, the customer's profile within the customer profile database may also include customer-specific retail information such as the customer's shopping or purchasing history. For example, a record of the items purchased during recent visits to the retailer's store may be included in the customer's profile. Moreover, a record may also be made in the customer's profile if the customer redeems a certain type of voucher or coupons or responds to a certain type of promotion.

As discussed above, contents of the customer profile database are utilized in order to generate customer-specific messages to the customer during a checkout transaction. In particular, transaction information such as item price and total dollar amount are displayed on the display monitor 66a. In addition to such transaction information, customer-specific advertisements may be displayed on a portion of the display monitor 66a in order to influence the customer to buy additional items. For example, the customer profile associated with a given customer may be initially retrieved from the customer profile database. Thereafter, the processing unit 66b causes customer-specific advertisements to be displayed on the display monitor 66b based on the contents of the customer's profile. For example, if the customer profile of a given customer indicates that the customer buys a certain type of beer during each of his or her visits to the retailer's store, the processing unit 66b may cause an advertisement for the certain type of beer to be displayed on the display monitor 66b in order to entice the customer to buy beer if it has not yet been entered into the checkout system 12. It should be appreciated that any type of criteria may be established to fit the needs of given retailer in regard to analyzing the contents of the customer profile database for the purposes of selecting an appropriate customer-specific advertisement message.

As discussed above, the processing unit 66b preferably includes a number of local memory devices such as the memory modules 66d (see FIG. 9) and a hard drive. The local memory devices are provided to maintain the operating system software needed to operate the checkout system 12. In addition, the local memory devices are provided to maintain an electronic transaction table which includes a record of the product information associated with each item that is scanned, weighed, or otherwise entered during the user's operation of the checkout system 12. For example, if the user scans a can of soup, the description of the soup and the pricing information associated therewith is recorded in the transaction table in the local memory devices. Similarly, if the user weighs a watermelon with the product scale 70 and then enters a product lookup code associated with watermelon via a data input device such as the terminal 66, product information associated with the watermelon is recorded in the transaction table. Moreover, if a user entered a coupon or voucher, the information associated therewith would also be recorded in the transaction table.

It should therefore be appreciated that the sum of each of the items recorded in the transaction table (1) minus any reductions (e.g., coupons), and (2) plus any applicable taxes is the amount that the customer pays for his or her transaction. Moreover, data stored in the transaction table is printed out on the receipt printer 110 thereby generating a receipt for the customer at the end of his or her transaction.

The local memory devices are also provided to maintain a number of electronic logs associated with operation of the checkout system 12. More specifically, the local memory devices electronically maintain a number of event logs each of which respectively tracks or otherwise tallies the number of occasions in which the user operates the checkout system 12 in a particular manner. An event log may be provided to track those occasions in which the user unintentionally operated the checkout system 12 improperly, along with those occasions in which it can be inferred with a high degree of confidence that the user intentionally operated the checkout system 12 improperly for illicit purposes such as theft. For example, if the processing unit 66b determines that the user placed an item in the post-scan area 200 without having previously scanned or otherwise entered the item into the system 12, an entry is made in an event log corresponding to such activity. The unscanned item may have been placed in the post scan area 200 as a result of the user unintentionally operating the scanner 68 incorrectly, thereby preventing the scanner 68 from reading the bar code printed on the item. However, the possibility does exist that the user may have intentionally prevented the scanner 68 from reading the bar code printed on the item (e.g., the user may have placed his or her thumb over the bar code during the scanning attempt). Therefore, an entry is made in an event log corresponding to such activity (i.e., placing an item in the post-scan area 200 without having first entered the item into the system 12).

Moreover, a separate event log may be maintained to track those occasions in which a user does not properly correct a prior misuse of the system 12. For example, if the processing unit 66b determines that the user placed an item into the post-scan area 200 without having previously scanned or otherwise entered the item into the system 12 in the manner discussed above, the processing unit 66b causes a message to be displayed on the display monitor 66a of the interactive customer interface terminal 66 which instructs the user to remove the item from the post-scan area 200 and thereafter properly enter the item. A separate event log is maintained in order to track the number of occasions in which the user does not follow such instruction or performs an additional improper operation. For example, if subsequent to such instruction the user removes a different item, or no item at all, from the post-scan area 200, an entry is made into the event log associated with such activity.

Additional examples of event logs which may be maintained include an event log which tracks the number of occasions in which the user weighs an item, such as produce, with the product scale 70, but then places an item of a different weight in the post-scan area 200. Moreover, a separate event log may be provided to track the number of occasions in which a user voids a first item from a transaction, but then removes a second item of lesser value from the post-scan area 200. A separate event log may be maintained to track the dollar amount of the coupons which are entered by a given user. Yet further, a separate event log may be provided to track the amount of time which elapses from the point in time at which the customer removes his or her items from the post-scan area 200 until the point in time at which the customer tenders payment for his or her items.

Moreover, the local memory devices maintain an electronic aggregate log. The aggregate log tracks the total of each of the various event logs. It should be appreciated that such an aggregate log is particularly useful for monitoring a user's “overall” operation of the checkout system 12. In particular, while the occurrence of certain individual activities by a given user may not separately rise to a level of concern, the aggregate of such activities may be of concern to the retailer.

It should be appreciated that a separate, predetermined threshold value may be established for each of the numerous event logs and also the aggregate log. More specifically, a retailer may establish a threshold value for each of the logs that once equaled or exceeded causes the processing unit 66b to communicate with certain system components in order to request intervention by retail personnel. In particular, when a threshold value associated with one of the event logs or the aggregate log is equaled or exceeded, the processing unit 66b may alert retail personnel as to certain events surrounding the operation of the checkout system 12 by a given user. After being alerted in such a manner, retail personnel will typically intervene into the transaction in order to either assist the user (in the case of inadvertent misuse of the system 12) or audit and/or discontinue the transaction (in the case of intentional misuse or theft). It should be appreciated that the processing unit 66b may also communicate with retail personnel via the status tri-light device 78.

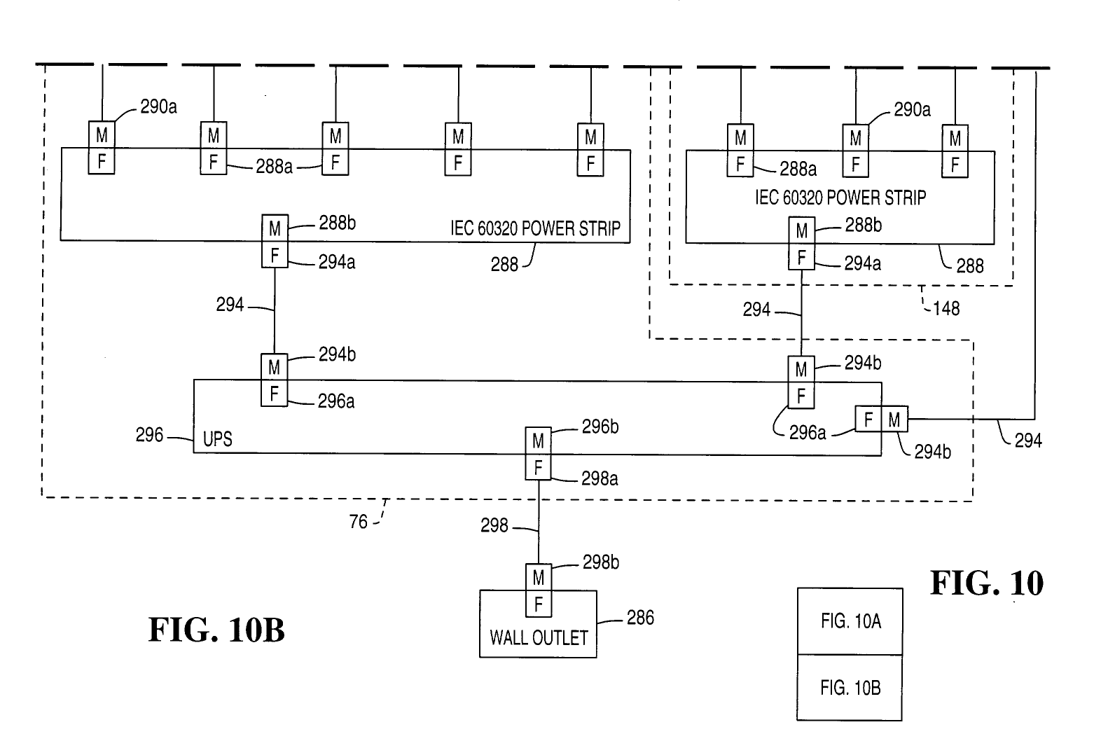

Referring now to FIG. 10, there is shown the power distribution scheme of the checkout system 12. Power is distributed from a wall outlet 286 to the system components associated with the checkout system 12 by use of a number of power strips 288. In particular, each of the power strips 288 is coupled to the wall outlet 286 via an uninterruptible power supply (UPS) 296, whereas each of the system components is electrically coupled to the power strips 288.

Use of the power strips 288 simplifies or otherwise enhances the cable management of the checkout system 12. In particular, the power strips 288 are preferably located in relatively close proximity to the retail peripheral devices to which the power strips 288 are respectively coupled thereby reducing the distance across which the individual power cables associated with each peripheral device must be routed. For instance, each one of the power strips 288 is mounted within the same module cabinet 76, 98, 148 which the retail peripheral devices coupled to the particular power strip 288 are disposed in or attached to. The exception to this is the receipt printer 110 which is disposed within the pedestal cabinet 112 but is connected to the power strip 288 in the core module cabinet 76. Since the receipt printer 110 is the only power-drawing device within the pedestal cabinet 112, a separate power strip 288 is not provided for the pedestal cabinet 112. However, it is to be understood that it is within the scope of the present invention to provide each module cabinet of the system, including the pedestal cabinet 112, with a respective power strip 288.

More specifically, as shown in FIG. 10, one of the power strips 288 is secured within the currency module cabinet 98 so as to be located in relatively close proximity to the electronic payment terminal 86, the coin dispenser 92, the coin acceptor 88, the coupon acceptor 94, and the bill acceptor 90. In such a configuration, the power cables 290 respectively associated with each of the devices 86, 88, 90, 92, 94 are completely contained within the currency module cabinet 98. Hence, in regard to the power strip 288 located in the terminal cabinet 98, only the power cable 294 which couples the power strip 288 located in the currency module cabinet 98 to the UPS 296 must be routed outside of the currency module cabinet 98.

Similarly to the power strip 288 within the currency module cabinet 98, one of the power strips 288 is secured within the core module cabinet 76 so as to be located in relatively close proximity to the scanner 68, the product scale 70, the bill dispenser 72, and the interface unit 240, all of which are disposed within the core module cabinet 76. Moreover, the power strip 288 secured within the core module cabinet 76 is also located in relatively close proximity to the customer interface terminal 66 attached to the core module cabinet 76, and, as discussed above, the receipt printer 110 disposed in the pedestal cabinet 112. In such a configuration, the power cables 290 respectively associated with each of the devices 68, 70, 72, 240 are completely contained within the core module cabinet 76. Moreover, since the UPS 296 is located within the core module cabinet 76, the power cable 294 that couples the power strip 288 located in the core module cabinet 76 to the UPS 296 is also completely contained within the core module cabinet 76. Hence, in regard to the power strip 288 located in the core module cabinet 76, the only power cable which must be routed outside of the core module cabinet 76 is the power cable 290 that couples the power strip 288 located in the core module cabinet 76 to the receipt printer 110 located in the pedestal cabinet 112.

Similarly to the power strips 288 within the core module cabinet 76 and the currency module cabinet 98, one of the power strips 288 is secured within the take-away belt module cabinet 148 so as to be located in relatively close proximity to the security scale 164, the security deactivation device 166, and the take-away belt motors 226 disposed within the take-away belt module cabinet 148. In such a configuration, the power cables 290 respectively associated with each of the devices 164, 166, 226 are completely contained within the take-away belt module cabinet 148. Hence, in regard to the power strip 288 located in the takeaway belt module cabinet 148, only the power cable 294 which couples the power strip 288 located in the take-away belt module cabinet 148 to the UPS 296 must be routed outside of the take-away belt module cabinet 148.

Moreover, the power strips 288 include a number of female power connectors 288a which are configured to receive a corresponding male connector 290a associated with a first end of a peripheral power cable 290. A second end of the peripheral power cable 290 includes a female connector 290b which is configured to be received into a male power connector 292 associated with each of the system components such as the interactive customer interface terminal 66, the interface unit 240, the assembly of the scanner 68 and the product scale 70, the receipt printer 110, the electronic payment terminal 86, the security scale 164, the security deactivation device 166, the take-away belt motors 226, the coin dispenser 92, the coin acceptor 88, the bill dispenser 72, the bill acceptor 90, and the coupon acceptor 94.

Each of the female connectors 288a, the male connectors 290a, the female connectors 290b, and the male connectors 292 is configured in accordance with an accepted international standard for power connectors. What is meant herein by the term “accepted international standard for power connectors” is a power connector standard which is promulgated by an international standards organization for use in substantially all countries. One such accepted international standard for power connectors includes an IEC 60320 international standard for power connectors (including all variations and iterations thereof) which is promulgated by the International Electrotechnical Commission (IEC).

Similarly, each of the power strips 288 includes a number of male power connectors 288b which are configured to receive a corresponding female connector 294a associated with a first end of a UPS power cable 294. A second end of the UPS power cable 294 includes a male connector 294b which is configured to be received into a female power connector 296a associated with the UPS 296. The male power connectors 288b, the female connectors 294a, the male connectors 294b, and the female power connectors 296a are each configured in accordance with an accepted international standard for power connectors such as the IEC 60320 international standard for power connectors.

Moreover, the UPS 296 includes a male power connector 296b which is configured to receive a corresponding female connector 298a associated with a first end of an outlet power cable 298. A second end of the outlet power cable 298 includes a male connector 298b which is configured to be received into a power outlet such as the wall outlet 286. The male power connector 296b and the female connector 298a are both configured in accordance with an accepted international standard for power connectors such as the IEC 60320 international standard for power connectors. However, the male power connector 296b is configured in accordance with an accepted country-specific standard for power connectors. What is meant herein by the term “accepted country-specific standard for power connectors” is a power connector standard which is promulgated by a national standards organization or a de facto standard which is otherwise in use within a particular country which may or may not conform to an accepted international standard for power connectors. One such accepted country-specific standard for power connectors includes a standard promulgated by the American National Standards Institute (ANSI) or the National Electrical Manufacturers Association (NEMA) for use in conjunction with the three-prong connector configuration widely utilized throughout the United States (e.g., NEMA 5-15P for plug connectors and NEMA 5-15R for the associated receptacle connectors).

Such use of power connectors which conform to the IEC 60320 international standard for power connectors provides the checkout system 12 with numerous advantages over heretofore designed checkout systems. For example, use of power connectors which conform to the IEC 60320 international standard for power connectors facilitates the importation process of the checkout system 12 into foreign countries. In particular, heretofore designed checkout systems utilize power strips and power cables which have numerous connectors which conform to an accepted country-specific standard for power connectors. For example, checkout systems designed and/or manufactured for use the United States typically have receptacles that have female connectors which conform to U.S. standards (e.g., an applicable ANSI and/or NEMA standard) for receiving a male connector associated with a power cord of a peripheral device which also conforms to U.S. standards (e.g., an applicable ANSI and/or NEMA standard). The female connector of the peripheral power cord (i.e., the connector secured to the end of the power cable which connects to the male connector of the peripheral device) may or may not be configured in accordance with an international standard for power connectors. For example, a number of peripheral devices include male power connectors which conform to the IEC 60320 international standard for power connectors. Hence, the power cable associated with such a peripheral device typically has a female power connector which conforms to the IEC 60320 international standard for power connectors for coupling with the male connector of the peripheral device at one end, and a standard U.S. male power connector (e.g., a male connector that conforms to an applicable ANSI and/or NEMA standard) on the other end for coupling with a standard U.S. outlet such as the standard U.S. female power connectors associated with a power receptacle.

However, when such use of standard U.S. power connectors is discovered by an inspection officer or the like during importation of the checkout system into a foreign country, the checkout system may be denied immediate entry into the foreign country. In particular, importation of the checkout system into the foreign country may be delayed until a certificate of conformance or the like is presented to the inspection officer. Such delays can often take weeks thereby significantly slowing the delivery process of the checkout system to a retailer located in a foreign country.

However, the checkout system 12 of the present invention avoids such delays. In particular, when the inspection officer inspects the checkout system 12 during importation thereof into a foreign country, all of the power connectors associated with the checkout system 12 conform to the IEC 60320 international standard for power connectors thereby eliminating the need for a certificate of conformance or other documentation in regard to the power distribution architecture of the system 12.

Moreover, only the outlet power cable 298 needs to be swapped in order to operate the checkout system 12 in various foreign countries. In particular, a different outlet power cable 298 having a male connector 298b which is configured to be received into the country-specific wall outlet of each foreign country may be utilized to couple the UPS 296 (and hence the power strips 288) to the wall outlet 286. In such a manner, power may be supplied to each of the system components associated with the checkout system. More specifically, each of the system components associated with the checkout system 12 includes an auto-ranging power supply (not shown) which is capable of converting a wide variety of AC input voltages into the regulated, predetermined DC voltage needed to operate the particular system component. For example, the individual power supplies respectively associated with each of the system components are configured to convert input power provided in either a European standard (e.g., 240V AC at 50 Hz), a U.S. standard (e.g., 110V AC at 60 Hz), or any other standard into the regulated, predetermined DC voltage needed to operate the particular system component. Hence, by swapping the outlet power cable 298 to fit into the country-specific wall outlet 286 of a given foreign country, power may be supplied to the system components without the need to also change any of the internal cable connections (i.e., the power cables 290 and 294) or power supplies within the checkout system 12.

It should be appreciated that the use of the power strips 288 and the port expander devices 208, 210, 212 provides for “modular construction” of the checkout system 12 by simplifying or otherwise enhancing the cable management of the checkout system 12. In particular, the port expander device 208, 210, 212 and the power strips 288 are preferably located in relatively close proximity to the retail peripheral devices to which the port expander devices 208, 210, 212 and the power strips 288 are respectively coupled thereby reducing the distance across which the individual data and power cables associated with each peripheral device must be routed. For instance, it is preferable to mount one or more of the port expander devices 208, 210, 212 and one or more of the power strips 288 within the same module cabinet 76, 98, 112, 148 in which the retail peripheral devices coupled to the particular port expander devices 208, 210, 212 or the particular power strips 288 are disposed.

In such a manner, as described above, each of the data and power cables associated with the retail peripheral devices are completely contained within the respective module cabinets 76, 98, 112, 148. This allows the system configuration of the checkout system 12 to be quickly and easily changed to fit the needs of a given retailer. For example, as shown in FIG. 3, in certain retail applications it may be desirable to configure the checkout system 44 without the take-away belt module 36. In such a configuration, a large bagwell 38 is utilized in lieu of the takeaway belt module 36. Such a change in the configuration of the checkout system is relatively easy to perform since the take-away belt module cabinet 148 does not have data or power cables routed therethrough, except for the cables necessary for operation of the components associated with the take-away belt module cabinet 148 (e.g., the security scale 164, the security deactivation device 166, and the take-away belt motors 226).

It should be appreciated that other module cabinet substitutions may also be quickly and easily performed due to such modular construction of the checkout system. For example, if a certain retailer does not desire a basket shelf 24 as shown in the checkout terminal 12 of FIG. 2, the basket shelf 24 may be removed and replaced with an input belt module 22 as shown in the checkout terminal 44 of FIG. 3.

The input belt module 22 includes a motor (not shown) for driving the input belt 50. The motor is connected to a wall outlet (not shown) through a user-operable switch (not shown).

### Operation of the Present Invention

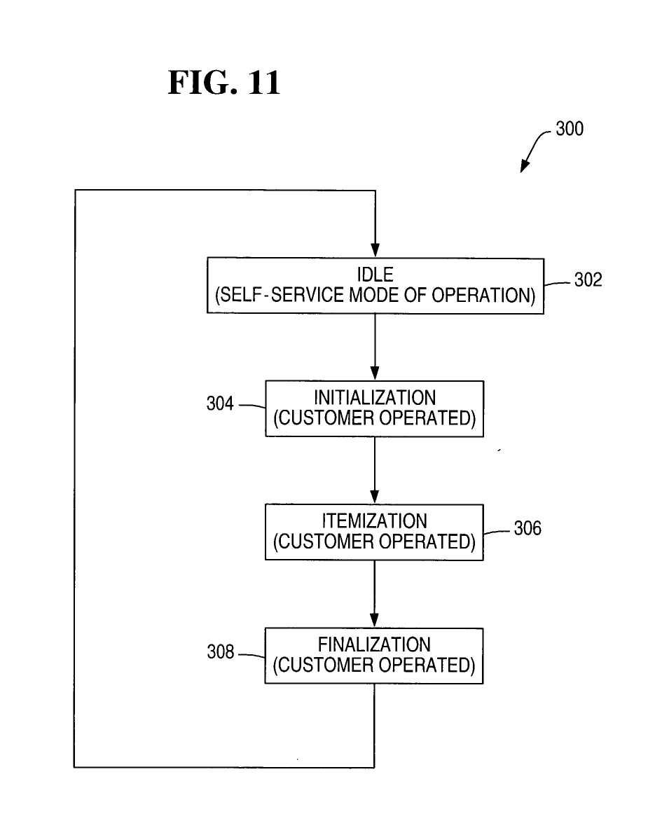

Referring now to FIG. 11, there is shown a flowchart which sets forth an exemplary general procedure 300 for checking out items through the checkout system. It should be appreciated that when the customer arrives at the checkout system, the system is in an idle state (step 302). An initialization step 304 is executed prior to checking out items for purchase. In particular, a message is displayed on the display monitor 66a associated with the interactive customer interface terminal 66 which instructs the customer to (1) to select a desired method of payment by touching a particular portion of the touch screen associated with the display monitor 66a, and/or (2) identify himself or herself by swiping his or her loyalty card, debit card, credit card, or smart card through the card reader associated with the electronic payment terminal 86.

At the completion of the initialization step 304, the routine 300 advances to an itemization step 306 where the customer enters the customer's individual items for purchase by scanning the items across the scanner 68. Moreover, in step 306, the customer may enter items, such as produce items or the like, by weighing the items with the product scale 70, and thereafter entering a product lookup code associated with the item via the touch screen associated with the display monitor 66a. Further, in step 306 the customer may enter an item by manually entering the product identification code associated with the item via use of the touch screen associated with the display monitor 66a. Such manual entry of an item may be necessary for items (which would otherwise be entered via the scanner 68) if the product identification code printed on the item is not readable by the scanner 68 or if the item is too large or bulky to be scanned with the scanner 68. It should be appreciated that the checkout system may be configured such that the routine 300 allows more experienced customers to bypass the initialization step 304 thereby advancing directly to the itemization step 306. In such a configuration, the customer would begin the transaction by scanning or otherwise entering his or her first item for purchase.

At the completion of the itemization step 306, an end-of-itemization control signal is generated and the routine 300 advances to a finalization step 308 in which (1) a transaction receipt is printed by the receipt printer 110, and (2) payment is tendered by either inserting currency into the currency acceptors (i.e., the coin acceptor 88 and/or the bill acceptor 90), charging a credit card or debit card account or decreasing a value amount stored on a smart card via the electronic payment terminal 86. In the case of when a customer inserts currency into the coin acceptor 88 and/or the bill acceptor 90, the checkout system may provide change via a currency dispenser (i.e., the coin dispenser 92 and/or the bill dispenser 72). After completion of the finalization step 308, the routine 300 returns to step 302 in which the checkout system remains in the idle condition until a subsequent customer initializes the system.

During operation of the checkout system 12, a number of software routines are executed to provide security from improprieties such as theft. For example, a scale security routine is executed in order to monitor the movement of items into and out of the post-scan area 200. More specifically, during operation of the checkout system 12, a scale security routine is executed which monitors the movement of items onto and off of the first take-away belt 138 in order to reduce the number of occasions in which the customer commits an impropriety such as theft.

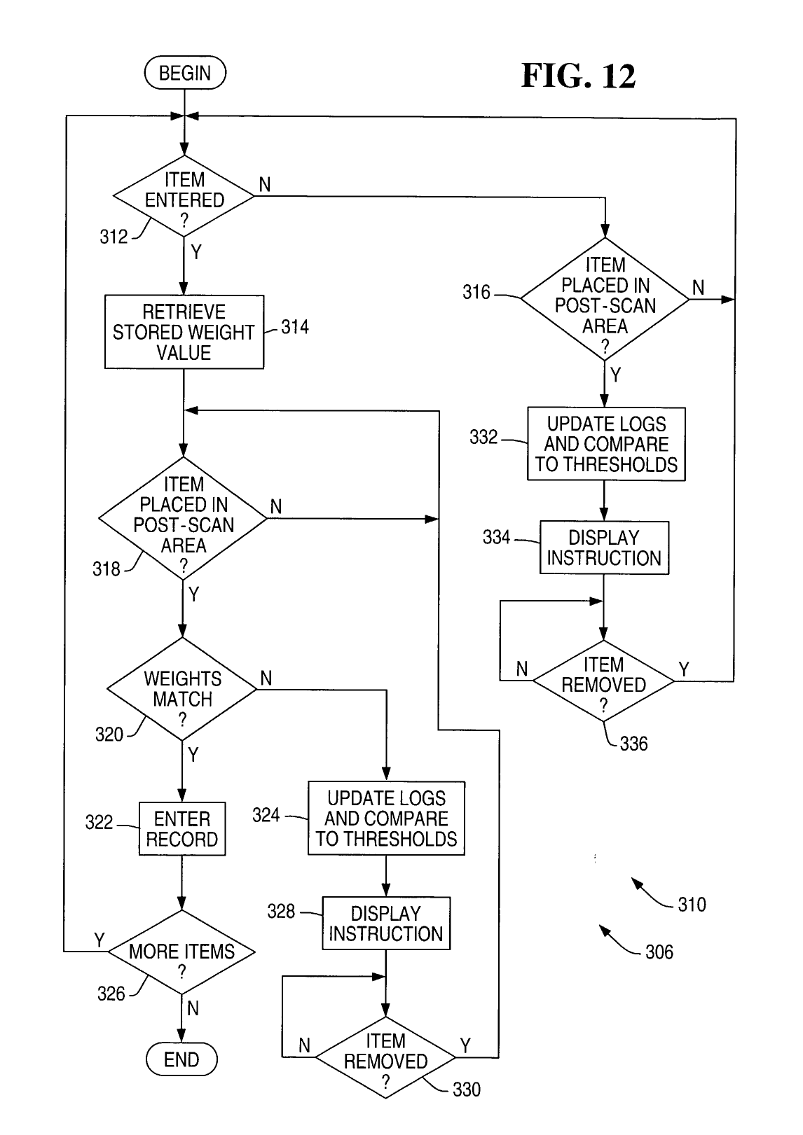

As shown in FIG. 12, a scale security routine 310 is executed during the itemization step 306 (see FIG. 11). The scale security routine 310 monitors output from the security scale 164 thereby monitoring the movement of items onto and off of the first take-away belt 138 in an effort to prevent, for example, a situation in which the user scans a first item, but then places a second, more expensive item, or even an item that the user never even attempted to scan, onto the first take-away belt 138 for subsequent bagging.

The scale security routine 310 begins with step 312 in which the processing unit 66b determines if an item has been entered into the checkout system 12 by the user. In particular, the processing unit 66b scans or reads the output from the scanner 68 in order to determine if the scanner 68 has successfully read or otherwise captured the product identification code associated with an item. More specifically, the scanner 68 generates an output signal which is sent to the processing unit 66b once the scanner 68 successfully reads the product identification code associated with the item. Similarly, the processing unit 66b scans or reads the output from the product scale 70 and the touch screen associated with the display monitor 66a to determine if the user weighed an item such as produce with the product scale 70 and thereafter entered a product lookup code associated with the item via the touch screen. Hence in step 312, if an item is entered into the checkout system 12, an item-entered control signal is generated and the scale security routine 310 advances to step 314. If an item has not been entered into the checkout system 12 by the user, the scale security routine 310 advances to step 316.

In step 314, the processing unit 66b retrieves a stored weight value of the entered item from a weight database. In particular, the processing unit 66b communicates with either a local memory device (e.g., the memory modules 66d or the hard drive) or a network memory device associated with the retailer's network 284 in order to retrieve the stored weight value associated with the entered item from the weight database. As discussed above, the weight database may be in the form of a master database which includes every item sold by the retailer, or may be a “transaction level” database which is constructed locally at the checkout system 12 during operation thereof. In either event, once the stored weight value of the entered item has been retrieved from the weight database, the scale security routine 310 advances to step 318.

In step 318, the processing unit 66b determines if the entered item is placed on the first take-away belt 138. More specifically, the security scale 164 generates an output or detection signal which is sent to the processing unit 66b once the security scale 164 has detected placement of an item onto the first take-away belt 138. If the security scale 164 detects placement of an item onto the first take-away belt 138, the scale security routine 310 is advanced to step 320. If the security scale 164 does not detect placement of the item onto the first take-away belt 138, the scale security routine 310 loops back to step 318 to monitor for subsequent placement of the item onto the first take-away belt 138. It should be appreciated that the checkout system 12 may be configured to allow for the entry of items without the item being subsequently placed onto the first take-away belt 138. For example, if the user scans a pack of gum, the user may place the gum into his or her pocket instead of a grocery bag. In such a situation, the scale security routine 310 would be configured to loop back to step 312 to monitor entry of subsequent items if a previously entered item is not placed onto the first take-away belt 138 within a predetermined time period.

As described above, if the security scale 164 detects placement of an item onto the first take-away belt 138, the scale security routine 310 is advanced to step 320. In step 320, the processing unit 66b determines if the measured weight value of the item placed onto the first take-away belt 138 (as detected by the security scale 164 in step 318) matches the stored weight value of the entered item that was retrieved from the weight database in step 314. What is meant herein by the terms “match”, “matches”, or “matching” in regard to weight values is that the magnitude of a first weight value is either equal to, or within a predetermined tolerance range of, the magnitude of a second weight value. For example, two weight values “match” if they are identical weight values. Moreover, a first weight value “matches” a second weight value if the first weight value is within 2% of the second weight value (assuming a 4% tolerance range). Yet further, a first weight value “matches” a second weight value if the first weight value is within 0.05 pound of the second weight value (assuming a tolerance range of 0.10 pound).

Hence, in step 320, the processing unit 66b compares the weight value of the item placed onto the first take-away belt 138 (as measured by the security scale 164) with the stored weight value of the entered item that was retrieved from the weight database in step 314. If the measured weight value of the item placed onto the first take-away belt 138 matches the stored weight value of the item retrieved from the weight database, the scale security routine 310 advances to step 322. If the measured weight value of the item placed onto the first take-away belt 138 does not match the stored weight value of the item retrieved from the weight database, the scale security routine 310 advances to step 324.

In step 322, the processing unit 66b determines that a successful checkout operation has been completed for the particular item selected for purchase. More specifically, the processing unit 66b concludes that (1) the user apparently scanned or otherwise entered the item since a code associated with the item was detected in step 312, and (2) the same item was placed onto the first take-away belt 138 since the weight values matched in step 320. Hence, the processing unit 66b adds a record of the properly entered item into the transaction table. In particular, the processing unit 66b communicates with the network 284 to obtain product information (e.g., description and price) associated with the entered item.

Thereafter, the processing unit 66b updates the transaction table. More specifically, the processing unit 66b generates an output signal which is sent to the local memory devices (e.g., the memory modules 66d or the hard drive) which causes the transaction table to be updated in the local memory devices to include the product information associated with the scanned item. As described above, the sum of each of the items recorded in the transaction table (1) minus any reductions (e.g., coupons), and (2) plus any applicable taxes is the amount that the customer pays for his or her transaction. Moreover, data stored in the transaction table is printed out on the receipt printer 110 thereby generating a receipt for the customer at the end of his or her transaction. Once the transaction table has been updated, a valid-use control signal is generated, and the scale security routine 310 advances to step 326.

In step 326, the processing unit 66b monitors the output from the touch screen 66a associated with the customer interface terminal 66. In particular, the user touches a particular area of the touch screen 66a when the user has completed scanning or otherwise entering all of the items for purchase. If a particular signal is generated by the touch screen 66a, the processing unit 66b determines that the itemization procedure 306 is complete and the scale security routine 310 ends thereby advancing the general routine 300 (see FIG. 11) to the finalization step 308. If a particular signal is not generated by the touch screen 66a, the processing unit 66b determines that the user has additional items to enter, and the scale security routine 310 loops back to step 312 to monitor subsequent item entry.

Returning now to step 320, if the measured weight value of the item placed onto the first take-away belt 138 does not match the stored weight value of the entered item retrieved from the weight database, the scale security routine advances to step 324. In step 324, the processing unit 66b increments the aggregate log and a particular event log associated with item substitutions by a predetermined value. More specifically, the processing unit 66b generates an output signal which is sent to the local memory devices (e.g., the memory modules 66d or the hard drive) which causes the event log and the aggregate log to be incremented in the local memory devices by a value of one.

Thereafter, the processing unit 66b determines if the total value of either the event log associated with item substitutions or the aggregate log exceeds the respective predetermined threshold value for each log. More specifically, if the event log associated with item substitutions exceeds its predetermined threshold value, the processing unit 66b causes an output signal to be generated which causes the status tri-light device 78 to be operated to summon retail personnel such as a manager in order to assist and/or investigate the user to determine if the user is attempting to provide himself or herself with improper benefits. In addition, if the aggregate log exceeds its predetermined threshold value, the processing unit 66b generates an output signal which causes the status tri-light device 78 to be operated to summon retail personnel such as a manager in order to assist and/or investigate the user in a similar manner. The scale security routine 310 then advances to step 328.

In step 328, the processing unit 66b causes a message to be displayed on the display screen 66a associated with the customer interface terminal 66 which instructs the user to remove the item from the post-scan area 200 and thereafter place the proper item onto the first take-away belt 138. The scale security routine 310 then advances to step 330.

In step 330, the processing unit 66b communicates with the security scale 164 in order to determine if the substituted item is removed from the first take-away belt 138 by the user, as instructed. In particular, the security scale 164 generates an output signal which is sent to the processing unit 66b when the user takes the substituted item off of the first take-away belt 138. It should be appreciated that the processing unit 66b compares the weight value of the removed item to the weight value of the substituted item that was determined when it was placed onto the first take-away belt 138 (as detected in step 318) in order to ensure that the proper item is removed. If the proper item is removed from the first takeaway belt 138, an item-removed control signal is generated and the scale security routine 310 loops back to step 318 to monitor subsequent placement of the correct item onto the first take-away belt 138. If the proper item has not yet been removed from the first take-away belt 138, the scale security routine 310 loops back to step 330 to monitor subsequent removal of the proper item from the first take-away belt 138.

Returning now to step 312, if an item was not scanned or otherwise entered into the checkout system 12, the scale security routine 310 advances to step 316. In step 316, the processing unit 66b determines if an unentered item is placed onto the first take-away belt 138. More specifically, the security scale 164 generates an output or detection signal which is sent to the processing unit 66b once the security scale 164 has detected placement of an item onto the first take-away belt 138. If the security scale 164 detects placement of an unentered item onto the first take-away belt 138, an invalid-use control signal is generated, and the scale security routine 310 is advanced to step 332. If the security scale 164 does not detect placement of an unentered item onto the first takeaway belt 138, the processing unit 66b concludes that there is no present item entry attempt being made by the user, and the scale security routine 310 loops back to step 312 to monitor for subsequent item entry.

In step 332, the processing unit 66b increments the aggregate log and a particular event log associated with unentered item placement (i.e., placement of an unentered item onto the first take-away belt 138) by a predetermined value. More specifically, the processing unit 66b generates an output signal which is sent to the local memory devices (e.g., the memory modules 66d or the hard drive) which causes the event log associated with unentered item placement and the aggregate log to be incremented in the local memory devices by a value of one.

Thereafter, the processing unit 66b determines if the total value of either the event log associated with unentered item placement or the aggregate log exceeds the respective predetermined threshold value for each log. More specifically, if the event log associated with unentered item placement exceeds its predetermined threshold value, the processing unit 66b causes an output signal to be generated which causes the status tri-light device 78 to be operated to summon retail personnel such as a manager in order to assist and/or investigate the user to determine if the user is attempting to provide improper benefits to himself or herself. In addition, if the aggregate log exceeds its predetermined threshold value, the processing unit 66b generates an output signal which causes the status tri-light device 78 to be operated to summon retail personnel such as a manager in order to assist and/or investigate the user in a similar manner. The scale security routine 310 then advances to step 334.

In step 334, the processing unit 66b causes a message to be displayed on the display screen 66a associated with the customer interface terminal 66 which instructs the user to remove the unentered item from the first take-away belt 138 and thereafter properly scan or otherwise enter the item into the checkout system 12. The scale security routine 310 then advances to step 336.

In step 336, the processing unit 66b communicates with the security scale 164 in order to determine if the unentered item is removed from the first take-away belt 138 by the user, as instructed. In particular, the security scale 164 generates a removal output signal which is sent to the processing unit 66b when the user takes the unentered item off of the first take-away belt 138. It should be appreciated that the processing unit 66b compares the weight value of the removed item to the weight value of the unentered item that was determined when it was placed onto the first take-away belt 138 (as detected in step 316) in order to ensure that the proper item is removed. In particular, the processing unit 66b generates a match control signal if the weight value of the removed item matches the weight value of the unentered item that was placed onto the first takeaway belt 138. In response to generation of the match control signal, the processing unit 66b causes a message to be displayed on the display screen 66a which instructs the user to re-enter the item. Hence, in step 336, if the proper item is removed from the first take-away belt 138, an item-removed control signal is generated and the scale security routine 310 loops back to step 312 to monitor subsequent entry of the item. If the proper item has not yet been removed from the first take-away belt 138, or a different item is removed, an instruction is displayed on the display screen 66a which instructs the user to remove the proper item, and the scale security routine 310 loops back to step 336 to monitor subsequent removal of the proper item from the first take-away belt 138.

As described above, use of the scale security routine 310 provides the checkout system 12 with numerous advantages over heretofore designed checkout systems. For example, as described in detail above, use of the scale security routine 310 provides security from improprieties by the user during operation of the checkout system 12.

It should be appreciated that other security mechanisms may also be operated during operation of the checkout system 12. For example, the security deactivation device 166 of the present invention is operated to generate a deactivation field in the form of a magnetic field or electromagnetic field during operation of the checkout system 12 so as to deactivate electronic tags associated with items for purchase after the items are scanned by the customer with the scanner 68. In particular, as described above, the security deactivation device 166 generates a deactivation field (e.g., a magnetic and/or electromagnetic field) downstream from a scanner detection zone associated with the scanner 68. By generating the deactivation field downstream from the scanner detection zone, the item is advanced through the deactivation field thereby deactivating the electronic security tag secured to the item after the item is scanned by the user.

By “automatically” deactivating the electronic security tag after the item is scanned by a customer (i.e., deactivating the tag during a scanning motion), the customer is not required to perform additional operations for the sole purpose to deactivating the tag prior to exiting the store. In particular, heretofore designed self-service checkout systems have required the customer to take his or her items for purchase to a centralized area such as a terminal operated by a retail clerk after the customer has completed his or her transaction in order to allow the clerk to determine which of the customer's items contain electronic security tags that need to be deactivated. Thereafter, the clerk manually deactivates each of the electronic security tags associated with the customer's items for purchase. It should be appreciated that the extra step of requiring the customer to take his or her items to the centralized area to deactivate the electronic security tags adds cost to the retailer's operation (e.g., the cost associated with staffing the centralized area with a retail clerk) and also creates an inconvenience for the customer by requiring the customer to spend additional time in the retailer's store. Such an inconvenience to the customer is augmented if a line or queue is present at the centralized area.

Hence, utilization of the security deactivation device 166 of the present invention solves such shortcomings of heretofore self-service checkout systems by deactivating the electronic security tag as part of routine entry of items into the checkout system 12 by the customer. In particular, utilization of the security deactivation device 166 eliminates the need for the retail clerk to intervene into the customer's transaction thereby reducing labor costs associated with the retailer's operation, along with increasing convenience to the customer by not requiring him or her to stand in a potentially long line or queue. Moreover, by generating the deactivation field proximate to the scanner detection zone such that the electronic security tag is deactivated as a result of an item scanning motion, the customer is not required to operate a separate deactivation-device such as a magnetic pad or the like thereby reducing the number of components that a customer is presented with during operation of the system 12.

It should be appreciated that the security deactivation device 166 may be configured to continuously generate the deactivation field (e.g., the magnetic or electromagnetic field), or may only generate the deactivation field once the product code associated with the item has been captured by the scanner 68. In particular, under the premise that the customer is likely not trying to commit an impropriety such as theft, the security deactivation device 166 may be configured to continuously generate the deactivation field such that the electronic security tag is deactivated whether or not the product code associated with the item is actually captured with the scanner 68. For example, if the customer attempts to scan the item with the scanner 68 (by advancing the item through the scanner detection zone with the bar code associated with the item facing one of the scanning windows 68a, 68b), but the product code is not captured by the scanner for any reason, the security deactivation device 166, if configured to continuously produce the deactivation field, may cause the electronic security label to be deactivated even though the item was not actually entered in the checkout system 12. However, in the case of operation of the checkout system 12 by an honest customer, such premature deactivation of the security tag is not an issue once the customer is subsequently successful at entering the item (e.g., by rescanning the item or manually entering the product code). It should be appreciated that the customer is likely to perform such re-scanning or manual entry of the item since the customer is not made aware of the fact that the electronic security tag has been deactivated.

However, to prevent the unlikely occurrence that the electronic security tag is prematurely deactivated and the item is not subsequently entered into the checkout system 12, the security deactivation device 166 may be configured to generate the deactivation field only after the product code associated with the item has been entered into the system 12. In particular, an item-entered control signal is generated when a product code associated with an item is captured by the scanner 68. In response to generation of the item-entered control signal, the security deactivation device 166 may be actuated so as to generate a deactivation field thereby deactivating the electronic security tag associated with the scanned item. In such a configuration, the location, width, and/or shape of the deactivation field generated by the security deactivation device 166 may be configured to ensure that the item is advanced therethrough during a handling motion subsequent to the scanning motion (e.g., the motion associated with placement of the item onto the first take-away belt 138).

As alluded to above, the status tri-light device 78 may be utilized during operation of the checkout system 12 in order to summon retail personnel to the checkout system 12. In particular, if during operation of the checkout system 12, an intervention-needed activity is detected, the status tri-light device 78 is operated so as to summon retail personnel such as a customer service manager in order to assist and/or investigate the customer's operation of the system 12. As described in detail above, such an intervention-needed activity may take the form of a security-breach activity in which the checkout system 12 is being operated in a manner which is placing the retailer in a position of potential financial loss due to goods being taken from the store without having first been paid for (either intentionally or unintentionally). An intervention-needed activity may also take the form of a non-security-breach activity in which the customer is in need of assistance or the checkout system 12 is in need of maintenance, but the retailer is not at risk of financial loss due to goods being taken from the store without having first been paid for. For example, if the customer scanned a first item, but then placed a second item of greater value into a grocery bag as detected by, for example, the security scale 68, the processing unit 66b concludes that an intervention-needed activity has occurred. Moreover, if the customer operating the system 12 touches a particular portion of the touch screen associated with the display monitor 66a; thereby indicating that he or she is in need of assistance, the processing unit 66b concludes that an intervention-needed activity has occurred.

In addition, the processing unit 66b may monitor the status of the retail peripheral devices associated with the checkout system 12 in order to determine if an intervention-needed activity has occurred. For example, the processing unit 66b preferably monitors the currency level within the coin dispenser 92 and the bill dispenser 72 in order to determine if either currency dispenser 72, 92 is in need of restocking. Moreover, the processing unit 66b preferably monitors the paper supply level within the receipt printer 110 in order to determine if the printer 110 is in need of restocking. It should be appreciated that if any one of the currency dispensers 72, 92 or the printer 110 is in need of restocking, the processing unit 66b concludes that an intervention-needed activity has occurred.

As described above, once an intervention-needed activity has been detected, the status tri-light device 78 is operated to summon retail personnel. For example, the status tri-light device 78 may display a first colored light (e.g., yellow) in order to notify retail personnel that intervention is needed prior to the end of the current checkout transaction. Alternatively, the status tri-light device 78 may display a second colored light (e.g., red) in order to notify retail personnel that intervention is needed immediately.

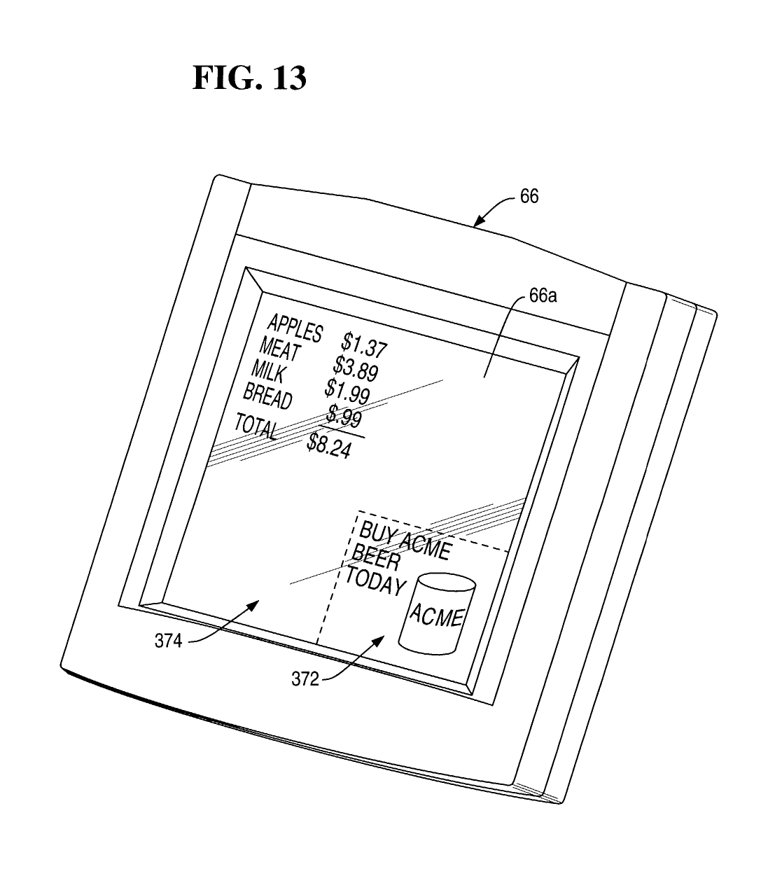

Additionally, during operation of the checkout system 12, the display monitor 66a of the interactive customer interface may be utilized to display certain information to the customer while the customer is entering his or her items for purchase. For example, a customer-specific message such as a customer-specific advertisement which advertises a product that was purchased by the customer during a previous visit to the retailer's store may be displayed on the first portion 372 of the display monitor 66a, as shown in FIG. 13, while transaction information such as item description and price is displayed on the second portion 374 of the display monitor 66a. In particular, during a self-service checkout transaction, the processing unit 66b retrieves information from a customer profile database which contains customer-specific information (e.g., previous purchases) about each of the retailer's customers. Hence, as shown in FIG. 13, if the customer routinely purchases “ACME BEER”, an advertisement for “ACME BEER” may be displayed on the first portion 372 of the display monitor 66a while the customer is entering the his or her items for purchase.

Moreover, such a customer-specific message may include a customer-specific advertisement which advertises a product which may be used in conjunction with a product which was previously scanned or otherwise entered into the checkout system 12 during the current checkout transaction. For example, if the customer scans a case of beer, an advertisement relating to pretzels may be displayed to the customer on the first portion 372 if the display monitor 66b since pretzels are commonly consumed with beer.

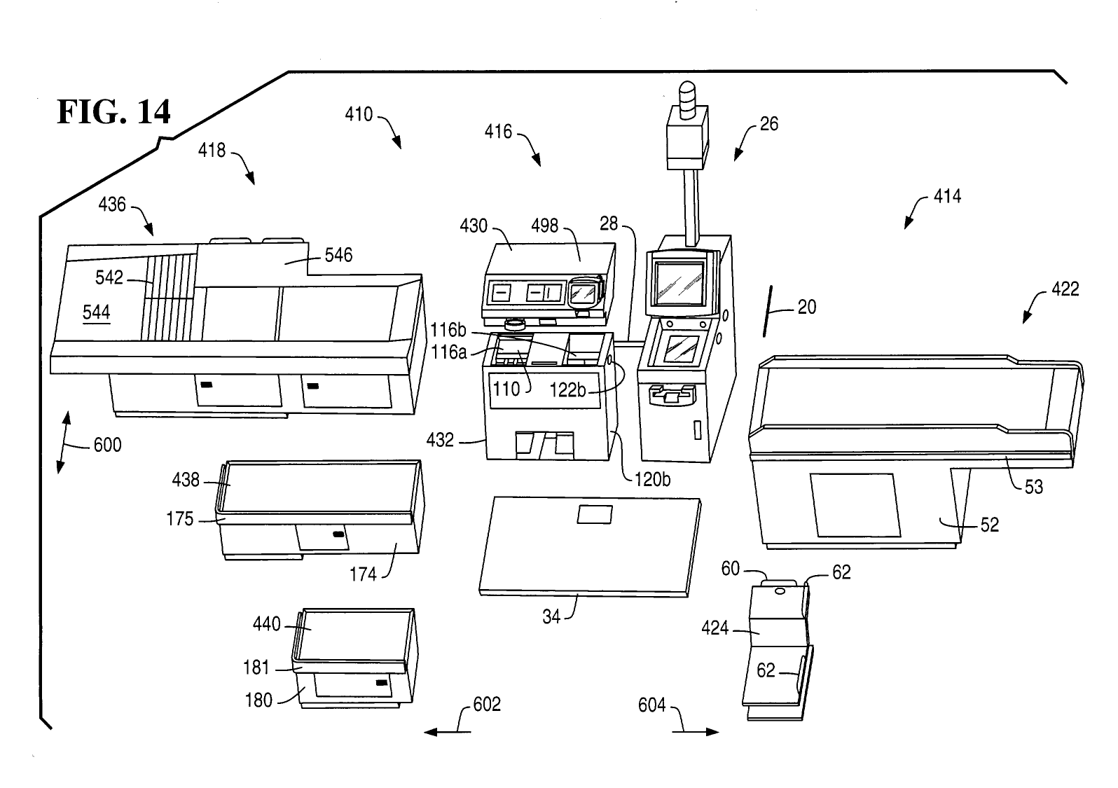

Referring now to FIG. 14, there is shown another embodiment of a modular self-service retail checkout terminal configuration kit 410 from which can be assembled, configured, designed, et cetera a self-service retail checkout terminal or system for use in a retail business such as a grocery store. Configuration kit 410 is right-hand configured, meaning that the items being purchased flow from right to left from the viewpoint of the user and from the viewpoint of FIG. 14. In contrast, the configuration kit 10 of FIG. 1 is left-hand configured, meaning that the items being purchased flow from left to right from the viewpoint of the user and from the viewpoint of FIG. 1. Unless mentioned, a terminal configured from the right-hand kit functions, operates, et cetera in the same manner as a terminal configured from the right-hand kit. In the left-hand configuration of FIG. 1, the one of the set 14 of input units that is selectively assembled with the set 16 of main units is disposed on the left-hand side of the user, as indicated by arrow 602. The user normally stands in front of the set 16 of main units. Further, the one of the set 18 of output units that is selectively assembled with the set 16 of main units is disposed on the right-hand side of the user, as indicated by arrow 604. In contrast, in the right-hand configuration of FIG. 14, the one of the set 414 of input units that is selectively assembled with the set 416 of main units is disposed on the right-hand side of the user, as indicated by arrow 604. The user normally stands in front of the set 416 of main units. Further, the one of the set 418 of output units that is selectively assembled with the set 416 of main units is disposed on the left-hand side of the user, as indicated by arrow 602.

It is desirable to have both right-hand and left-hand configurations because of the space savings provided thereby. More particularly, a left-hand terminal can be set up facing a right-hand terminal such that the two terminals share a common aisle on which a user can approach the terminals. Another advantage of having both right-hand and left-hand self-service terminals facing in opposite directions in a store checkout area is that a potential customer can always see the face of a terminal regardless of the direction from which the customer is approaching the checkout area. Because the customer is able to see the face of the terminal during his or her approach to the checkout area, the customer is more likely to use one of the self-service checkout terminals rather than go to a full-service checkout terminal, which is more expensive for the retailer to operate.

For purposes of the following discussion, the self-service checkout terminal configuration kit 410 will be described in detail. However, it should be appreciated that an assisted checkout terminal (i.e., a retail checkout terminal which is operated by a store employee such as a checkout clerk) may be configured in a similar manner.

The checkout system configuration kit 410 includes a set 414 of input units, a set 416 of main units, and a set 418 of output units. The set 414 of input units includes the side bumper 20, an input belt module 422 and a basket shelf 424. The set 416 of main units includes the core module 26, the back bumper 28, an upper currency module 430, a pedestal 432 and the base 34. The set 418 of output units includes a take-away belt module 436, a large bagwell 438 and a small bagwell 440.

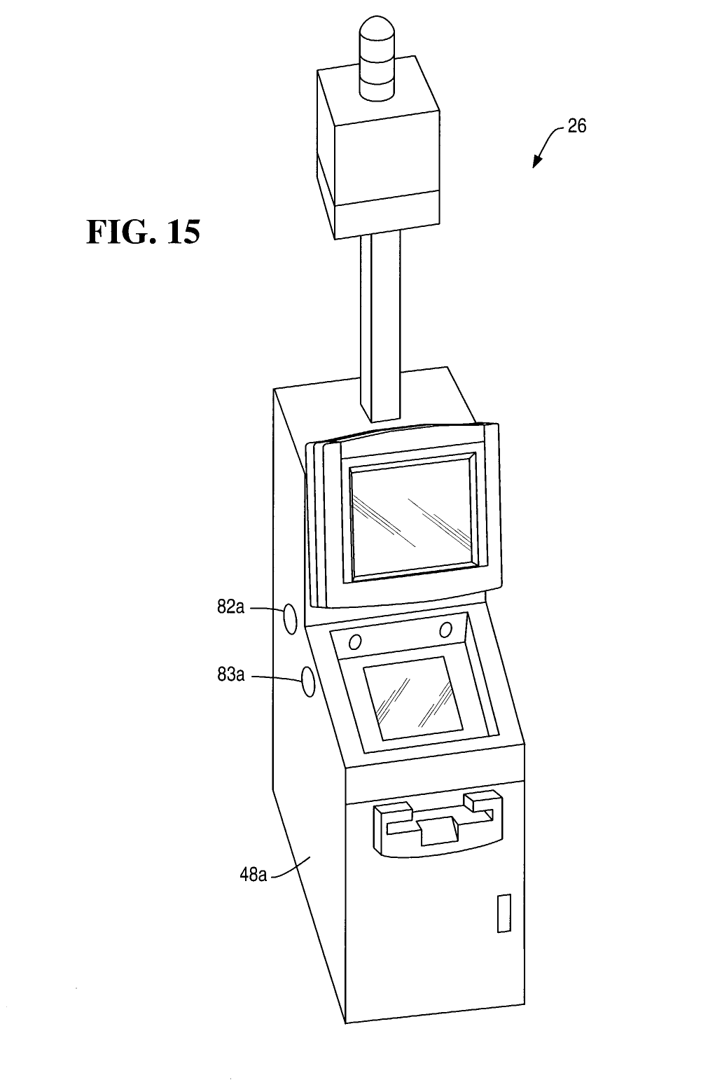

Some of the components of configuration kit 410 are identical to the corresponding components in configuration kit 10 (see FIG. 1). More particularly, each of the side bumper 20, the core module 26, the back bumper 28 and the base 34 can be used in either the left-hand configuration of kit 10 or the right-hand configuration of kit 410. More particularly, the side bumper 20 is selectively positionable on either the right-hand side or the left-hand side of the core module 26. Further, the core module 26 is selectively positionable on either the right-hand side or the left-hand side of the base 34. Core module cabinet 76 includes knockouts 82a, 83a (FIG. 15) on side surface 48a which are located identically as (i.e., as the mirror image of) the knockouts 82b, 83b on the side surface 48b.

The security deactivation module 186 can also be used in both left-hand and right-hand configurations. That is, the security deactivation module is selectively positionable on a right-hand side or a left-hand side of the core module 26. When used in the right-hand configuration, the security deactivation module 186 is oriented such that the knockout 194a (see FIG. 8) of the security deactivation cabinet 190 is aligned with the knockout 83a of the core module cabinet 76. Thus, cabling can be routed through the aligned knockouts 83a, 194a.

Some other ones of the components of configuration kit 410 differ from their counterparts in configuration kit 10 only in the placement or mounting of some parts. More particularly, the pedestal 432 differs from pedestal 32 only in that the printer 110 is mounted in the left-hand side throughhole 116a of pedestal 432, while, in contrast, the printer 110 is mounted in the right-hand side throughhole 116b of the pedestal 32. Also, the cabling to the upper currency module is routed through the right-hand side throughhole 116b of the pedestal 432, while, in contrast, the cabling to the upper currency module is routed through the left-hand side throughhole 116a of the pedestal 32. Moreover, the cabling to the core module 26 is routed through a right-hand side knockout 122b of a right side wall 120b of the pedestal 432, while, in contrast, the cabling to the core module 26 is routed through the left-hand side knockout 122a of the left side wall 120a of the pedestal 32. However, the pedestal 32 and the pedestal 432 include the same parts, with only the arrangement of the parts differing between the pedestal 32 and the pedestal 432. The pedestal 432 is the mirror image of the pedestal 32.

The input belt module 422 of configuration kit 410 differs from the input belt module 22 of configuration kit 10 only in that the bumper 53 is placed on an opposite side of the input belt cabinet 52. The input belt module 422 is the mirror image of the input belt module 22. It is easy to convert one of the input belt modules 22 and 422 into the other with a minor mounting change of the bumper 53. Thus, the input belt module is selectively positionable on either the right-hand side or the left-hand side of the core module 26.

The large bagwell 438 of configuration kit 410 differs from the large bagwell 38 of configuration kit 10 only in that the bumper 175 is placed on an opposite side of the large bagwell cabinet 174. The large bagwell 438 is the mirror image of the large bagwell 38. It is easy to convert one of the large bagwell 38 and 438 into the other with a minor mounting change of the bumper 175. Thus, the large bagger is selectively positionable on either the right-hand side or the left-hand side of the core module 26.

The small bagwell 440 of configuration kit 410 differs from the small bagwell 40 of configuration kit 10 only in that the bumper 181 is placed on an opposite side of the small bagwell cabinet 180. The small bagwell 440 is the mirror image of the small bagwell 40. It is easy to convert one of the small bagwells 40 and 440 into the other with a minor mounting change of the bumper 181. Thus, the small bagger is selectively positionable on either the right-hand side or the left-hand side of the core module 26.

The remaining ones of the components of configuration kit 410 have structural differences from their counterparts in configuration kit 10. Thus, these components are not used in both right-hand and left-hand configurations, and both right-hand and left-hand versions of these components are provided.

More particularly, the take-away belt module 436 of configuration kit 410 is the mirror image of the take-away belt module 36 of configuration kit 10. A bagging counter 544 and a set aside shelf 546 are mounted on the take-away belt module 436 such that they extend away from the user, as do the bagging counter 144 and the set aside shelf 146 of the take-away belt module 36. Although the present invention includes a separate left-hand version 36 and a right-hand version 436 of the takeaway belt module, it would be possible to provide a take-away belt module that can be easily switched between right-hand and left-hand configurations. More particularly, the take-away belt module could include a bagging counter that is slidable in directions indicated by double arrow 600 to accommodate both right-hand and left-hand configurations. The take-away belt module could also include a set aside shelf that is easily detached and reattached to an opposite side of the take-away belt module cabinet in order to accommodate both right-hand and left-hand configurations.

The currency module 430 of the configuration kit 410 is the mirror image of the currency module 30 of the configuration kit 10. Moreover, the currency module cabinet 498 is the mirror image of the currency module cabinet 98. Thus, the positions of the electronic payment terminal 86, the coin acceptor 88, the bill acceptor 90, the coin dispenser 92 and the coupon acceptor 94 are reversed in the currency module 430 as compared to the currency module 30. For example, the electronic payment terminal 86 is on the left-hand side of the currency module 430, while, in contrast, the electronic payment terminal 86 is on the right-hand side of the currency module 30.

The basket shelf 24 of the configuration kit 410 is the mirror image of the basket shelf 24 of the configuration kit 10. More particularly, the side rails 62 are mounted on the right-hand side of the shelf 424, while, in contrast, the side rails 62 are mounted on the left-hand side of the shelf 24. Although the present invention includes a separate left-hand version 24 and a right-hand version 424 of the basket shelf, it would be possible to provide a basket shelf that can be easily switched between right-hand and left-hand configurations. More particularly, the basket shelf could include side rails that can be easily detached from the left-hand side of the shelf and reattached to the right-hand side of the shelf, and vice versa, to accommodate both right-hand and left-hand configurations.

As described above in detail, the checkout system 12 of the present invention provides numerous advantages over heretofore designed checkout systems. For example, the checkout system 12 of the present invention can be quickly and easily modified by swapping the one of the set 14 of input units that is currently installed with another one of the set 14 of input units. Similarly, the checkout system 12 can be quickly and easily modified by swapping the one of the set 18 of output units that is currently installed with another one of the set 18 of output units.

Further, the modular form of the components of the terminal configuration kit 10 allows any one of the components to be easily removed from the checkout system and replaced with an upgraded model of that particular component. Because the components have their own separate cabinets, power strips and USB port expander devices, any one of the components of an assembled terminal can be quickly and easily removed from the terminal and replaced with an upgraded version. More particularly, any one of the input belt module, the bumpers, the basket shelf, the core module, the pedestal, the currency module, the base, the take-away belt module, the large bagger, the small bagger and the security deactivation module can be easily removed and/or installed into an assembled checkout system.

Another advantage is that many components of the terminal configuration kit 10 of the present invention can be used in both left-hand and right-hand configurations, or at least can be switched between left-hand and right-hand configurations after some minor mounting adjustments. This makes it easier for a retailer to convert a checkout terminal from a right-hand to a left-hand configuration, and vice versa. It also reduces the number of components that the retailer and the distributor of the checkout systems must keep in inventory, since both right-hand and left-hand versions of the components are not needed in all cases.

A further advantage of the terminal configuration kit 10 is that the components are in modular form and have their own cabinets. This allows the component modules to be easily rearranged and assembled into either a left-hand or a right-hand configuration.

Yet further, the terminal configuration kit 10 of the present invention provides a checkout system that can be imported into numerous foreign countries with minimal effort during the importation process in regard to compliance of local electrical standards. In addition, the terminal configuration kit 10 of the present invention provides a checkout system has enhanced data and power cable routing management relative to heretofore designed checkout systems. Moreover, the terminal configuration kit 10 of the present invention provides a checkout system which may be constructed of “off the shelf”, industry-standard retail peripheral devices thereby substantially eliminating costs associated with development of proprietary data transmission and power architectures.

While the invention has been illustrated and described in detail in the drawings and foregoing description, such an illustration and description is to be considered as exemplary and not restrictive in character, it being understood that only the preferred embodiment has been shown and described and that all changes and modifications that come within the spirit of the invention are desired to be protected.

There are a plurality of advantages of the present invention arising from the various features of the checkout system described herein. It will be noted that alternative embodiments of the checkout system of the present invention may not include all of the features described yet still benefit from at least some of the advantages of such features. Those of ordinary skill in the art may readily devise their own implementations of a terminal configuration kit or a checkout system that incorporate one or more of the features of the present invention and fall within the spirit and scope of the present invention as defined by the appended claims.

What is claimed is:

1. A modular self checkout terminal configuration kit, comprising:
a set of input modules operative to position a plurality of items for processing;
a set of main modules operative to process the items; and
a set of output modules operative to position the items for bagging;
wherein a modular self checkout terminal is configured from one input module of said set of input modules, one main module of said set of main modules, and one output module of said set of output modules.

2. The kit of claim 1 wherein:
said set of input modules includes at least one of a bumper, an input belt module and a shelf;
said one main module comprises a first main module including at least one of a scanner and a weight scale; and
said set of output modules includes at least one of a take-away belt module and a bagwell.

3. The kit of claim 2, wherein:
said first main module includes a user interface configured to face a user,
each said input module is selectively positionable relative to said first main module such that said input module is on one of a right-hand side of the user and a left-hand side of the user, and
each said output module is selectively positionable relative to said first main module such that said output module is on an other of the right-hand side of the user and the left-hand side of the user.

4. The kit of claim 3, wherein:
said first main module comprises a core module, said kit further comprising a second main module comprising a currency module, and
said first main module and said second main module are selectively arrangable such that said currency module is on one of a right-hand side and a left-hand side of said core module relative to the user.

5. A retail terminal, comprising:
an input module including at least one of a first bumper, an input belt module and a shelf;
an output module including at least one of a take-away belt module and a bagwell; and
a first main module including at least one of a scanner and a first weight scale, said first main module being associated with said input module and with said output module, said first main module having a first main cabinet separate from said input module and from said output module.

6. The retail terminal of claim 5, wherein said input module includes said input belt module, said input belt module having an input cabinet separate from said first main cabinet.

7. The retail terminal of claim 5, wherein said output module includes an output cabinet separate from said first main cabinet.

8. The retail terminal of claim 5, wherein:
said first main module includes a user interface configured to face a user,
said input module is selectively positionable relative to said first main module such that said input module is on one of a right-hand side of the user and a left-hand side of the user, and
said output module is selectively positionable relative to said first main module such that said output module is on an other of the right-hand side of the user and the left-hand side of the user.

9. The retail terminal of claim 8, wherein:
said first main module comprises a core module, said retail terminal further comprising a second main module comprising a currency module, and
said first main cabinet comprises a core module cabinet, said second main module having a second main cabinet comprising a currency module cabinet.

10. The retail terminal of claim 9, wherein said core module and said currency module are selectively arrangable such that said currency module cabinet is on one of a right-hand side and a left-hand side of said core module cabinet relative to the user.

11. The retail terminal of claim 9, wherein said currency module includes at least one of an electronic funds transfer device, a receipt printer, a cash acceptor, a coin acceptor, a coupon acceptor and a coin dispenser.

12. The retail terminal of claim 9, further comprising:
a third main module comprising a pedestal supporting said currency module, and
a fourth main module comprising a base supporting each of said core module and said pedestal.

13. The retail terminal of claim 8, wherein said retail terminal further comprises a second bumper configured to be attached to a back side of said first main module opposite said user interface.

14. The retail terminal of claim 5, wherein said first main module is connected to at least one of said input module and said output module.

15. The retail terminal of claim 5, wherein said output module includes a second weight scale.

16. The retail terminal of claim 15, wherein said second weight scale comprises a security scale.

17. The retail terminal of claim 5, wherein said output module includes said take-away belt module, said take-away belt module having a first take-away belt and a second take-away belt arranged in series.

18. The retail terminal of claim 5, wherein said output module includes a security deactivation device.

19. The retail terminal of claim 5, wherein said first main module includes a processor configured to control said output module.

20. A method of configuring a modular self-checkout station, comprising the steps of:
selecting one input module from a set of input modules;
selecting one main module from a set of main modules;
selecting one output module from a set of output modules; and
assembling the selected one input module, the selected one main module, and the selected output module into a modular self-checkout station.

21. The method of claim 20, wherein said one input module is selected from left-hand sets and right-hand sets of said input modules, said one main module is selected from left-hand sets and right-hand sets of said main modules, and said one output module is selected from left-hand sets and right-hand sets of said output modules to thereby yield one of a right-hand modular self-checkout station and a left-hand modular self-checkout station.

22 The method of claim 20 wherein:
said set of input modules includes at least one of a bumper, an input belt module and a shelf;
said one main module comprises a first main module including at least one of a scanner and a weight scale; and
said set of output modules includes at least one of a take-away belt module and a bagwell.

23. The method of claim 22, wherein:
said first main module includes a user interface configured to face a user,
each said input module is selectively positionable relative to said first main module such that said input module is on one of a right-hand side of the user and a left-hand side of the user, and
each said output module is selectively positionable relative to said first main module such that said output module is on an other of the right-hand side of the user and the left-hand side of the user.

24. The method of claim 23, wherein:
said first main module comprises a core module, said method further comprising selecting a second main module from said set of main modules, said second main module comprising a currency module, and
said first main module and said second main module are selectively arrangable such that said currency module is on one of a right-hand side and a left-hand side of said core module relative to the user.
